(19) United States
(12) Patent Application Publication
(10) Pub. No.: US 2025/0317809 A1
(43) Pub. Date: Oct. 9, 2025

(54) METHOD AND APPARATUS FOR CONDITIONAL MOBILITY BASED ON MEASUREMENT PREDICTION IN A WIRELESS COMMUNICATION SYSTEM

(71) Applicant: LG ELECTRONICS INC., Seoul (KR)

(72) Inventors: Myoungsoo KIM, Seoul (KR); Sunghoon JUNG, Seoul (KR)

(21) Appl. No.: 18/866,871

(22) PCT Filed: Jun. 15, 2023
(86) PCT No.: PCT/KR2023/008275

§ 371 Date: Nov. 18, 2024

Related U.S. Application Data
(60) Provisional application No. 63/353,640, filed on Jun. 20, 2022.

(51) Int. Cl. H04W 36/00

(52) U.S. Cl. CPC H04W 36/0058; H04W 36/0085

(57) ABSTRACT

A method and apparatus for conditional mobility based on measurement prediction in a wireless communication system is provided. A wireless device receives, from a network, a configuration of a conditional mobility for a target cell including at least one condition. A wireless device acquires a present measurement result for the target cell at a first time point. A wireless device derives a predictive measurement result for the target cell for a second time point. A wireless device performs the conditional mobility to the target cell based on both the present measurement result and the predictive measurement result satisfying the at least one condition.

### CROSS-REFERENCE TO RELATED APPLICATIONS

This application is the National Stage filing under 35 U.S.C. 371 of International Application No. PCT/KR2023/008275, filed on Jun. 15, 2023, which claims the benefit of U.S. Provisional Applications No. 63/353,640 filed on Jun. 20, 2022, which is hereby incorporated by reference herein in its entirety.

### TECHNICAL FIELD

The present disclosure relates to a method and apparatus for conditional mobility based on measurement prediction in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

The application of AI/ML in wireless communication has been studied to enhance the overall network and user equipment (UE) operations, thereby improving performance and enabling the provision of various services. By utilizing AI/ML, both networks and UEs can anticipate mobility and share the outcomes to enhance performance.

To enhance mobility robustness and reduce latency for mobility execution, conditional mobility techniques such as CHO, CPC, and CPA have been introduced. When the network configures the UE with one or more candidate target cells for conditional mobility, the UE evaluates the condition of each configured candidate target cell. If the execution condition for conditional mobility is met by any of the target cells, the UE performs conditional mobility to that cell.

In the context of 6G, the THz band may be employed to meet the requirement of Tbps data rates due to its enormous available bandwidth. However, in this high-frequency coverage, the cell coverage would decrease, resulting in more frequent execution of conditional mobility. This increased frequency can lead to mobility occurring too early, too late, or to the wrong cell. Mobility failures result in low reliability and high latency, which hinder the achievement of high data rates. To optimize the conditional mobility process in a high-frequency environment, AI/ML can assist in predicting the appropriate cell for executing conditional mobility.

Therefore, studies for conditional mobility based on measurement prediction in a wireless communication system are required.

In an aspect, a method performed by a wireless device in a wireless communication system is provided. A wireless device receives, from a network, a configuration of a conditional mobility for a target cell including at least one condition. A wireless device acquires a present measurement result for the target cell at a first time point. A wireless device derives a predictive measurement result for the target cell for a second time point. A wireless device performs the conditional mobility to the target cell based on both the present measurement result and the predictive measurement result satisfying the at least one condition.

In another aspect, an apparatus for implementing the above method is provided.

The present disclosure can have various advantageous effects.

According to some embodiments of the present disclosure, a wireless device could efficiently handle execution of conditional mobility based on current measurement result and predictive measurement result.

For example, if the UE performs conditional mobility to the cell with guaranteed cell quality until the future, it is possible to increase mobility robustness and reduce latency for mobility execution in high frequency coverage.

In other words, by enabling the UE to perform conditional mobility to a cell with guaranteed cell quality in the future, it becomes feasible to enhance mobility robustness and reduce latency for mobility execution in high-frequency coverage.

For example, by performing CHO based on predictive measurement results, it is possible to improve the efficiency of handover.

For example, by utilizing both predictive measurement results and actual measurement results, it becomes possible to receive stable services from the target cell.

According to some embodiments of the present disclosure, a wireless network system could provide an efficient solution for conditional mobility considering measurement prediction.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a Functional Framework for RAN Intelligence.

FIG. 11 shows an example of an AI/ML Model Training in OAM and AI/ML Model Inference in NG-RAN node.

FIG. 12 shows an example of Model Training and Model Inference both located in RAN node.

FIGS. 13 and 14 show an example of an architecture of neuron and neural network.

FIG. 15 shows an example of an AI/ML inference.

FIG. 16 shows an example of an MLP DNN model.

FIG. 17 shows an example of a CNN model.

FIG. 18 shows an example of an RNN model.

FIG. 19 shows an example of Reinforcement learning.

FIG. 20 shows an example of measurement reporting.

FIG. 21 shows an example of a method for conditional mobility based on measurement prediction in a wireless communication system, according to some embodiments of the present disclosure.

FIG. 22 shows an example of a method for conditional mobility based on measurement prediction in a wireless communication system, according to some embodiments of the present disclosure.

FIGS. 23 and 24 show examples of execution of conditional mobility based on current measurement result and predictive measurement result for a particular time.

FIGS. 25 and 26 show examples of execution of conditional mobility based on current measurement result and predictive measurement result for a certain time with prediction time window for a minimal value.

FIGS. 27 and 28 show examples of execution of conditional mobility based on current measurement result and predictive measurement result for a certain time with prediction time window for a maximum value.

FIGS. 29 and 30 show examples of execution of conditional mobility based on current measurement result and predictive measurement result for a certain time.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

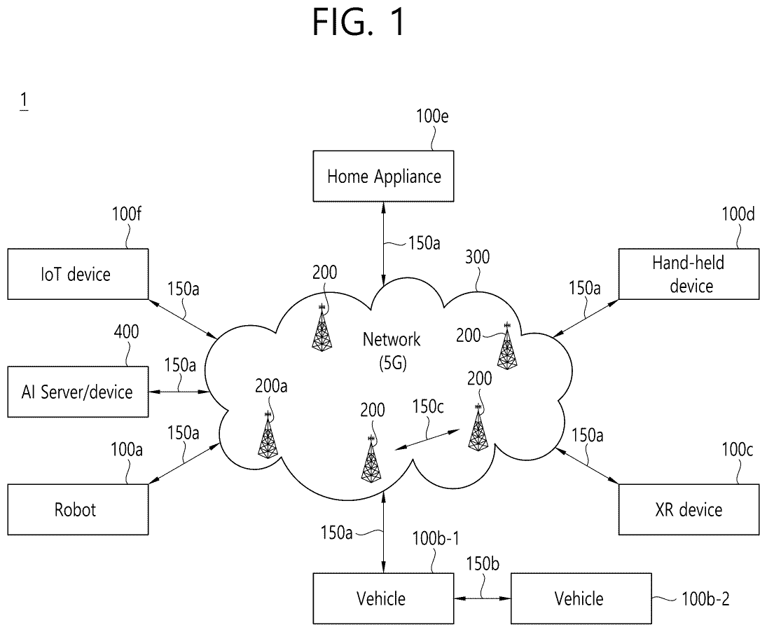

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

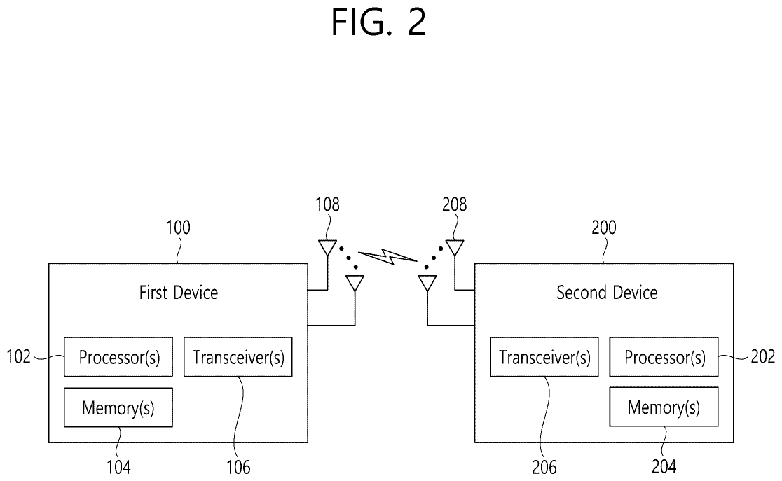

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to '} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

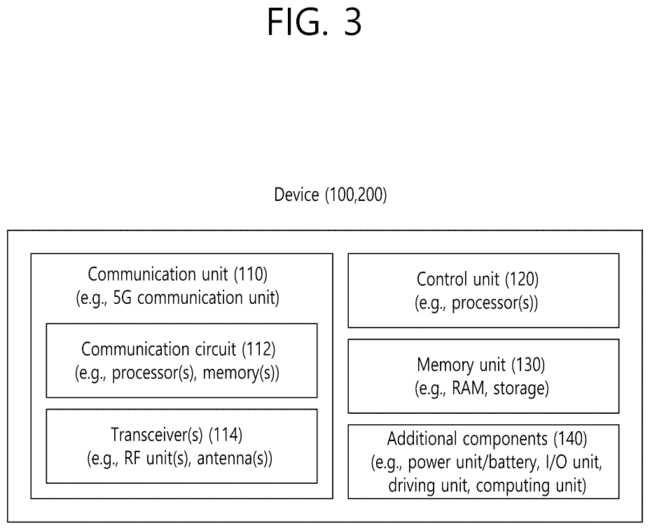

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

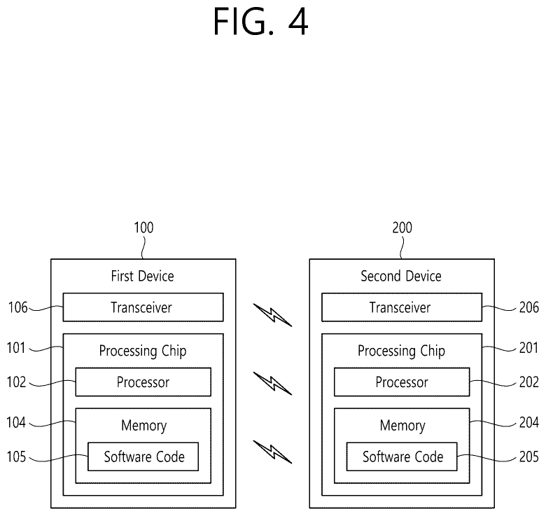

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

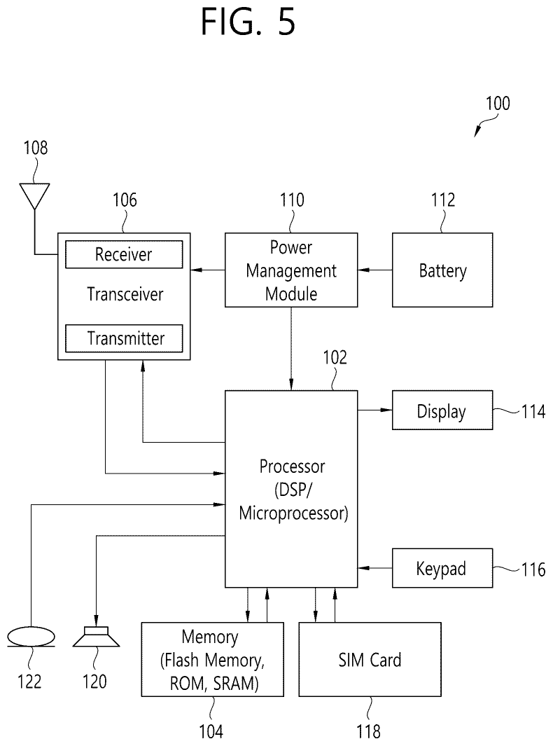

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor.

The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

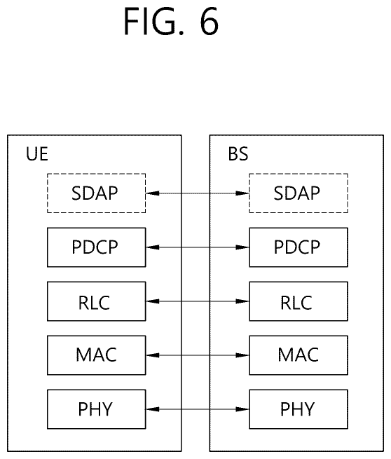

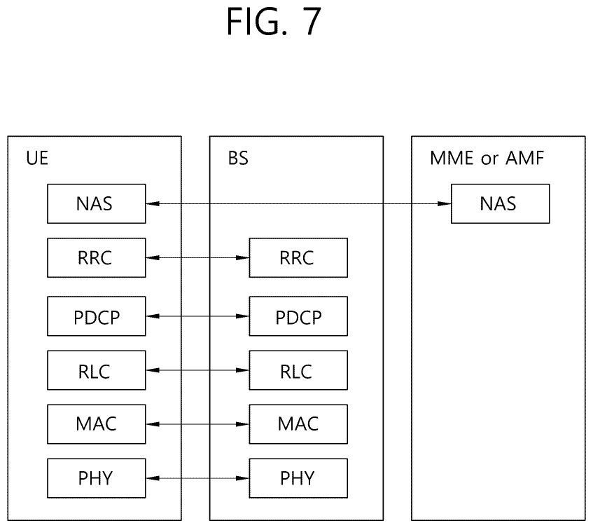

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology (ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

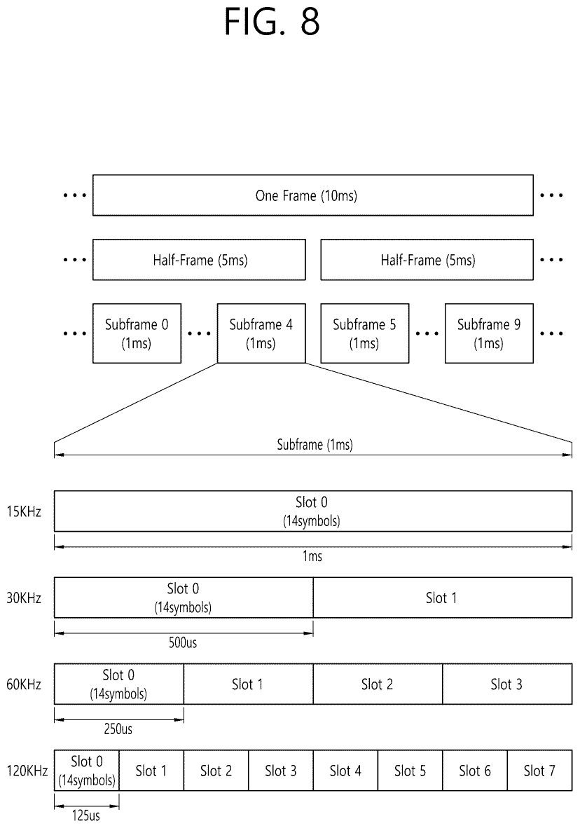

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FRI may mean “sub 6 GHz range”, FR2 may mean “above 6 GHz range,” and may be referred to as millimeter wave (mmW).

TABLE 3

| Frequency Range | Corresponding frequency | | |
|---|---|---|---|
| designation | range | Subcarrier Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 4 below. That is, FRI may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

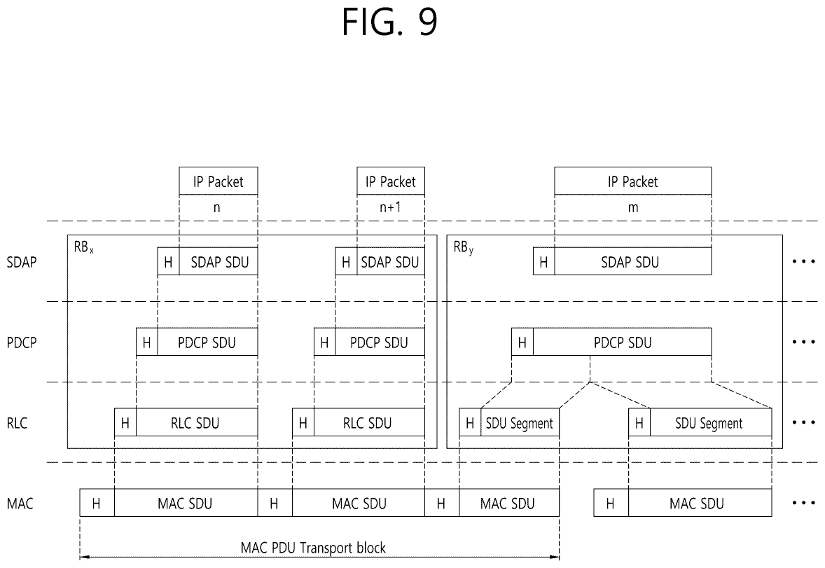

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to AI/ML are described.

The application of AI/ML to wireless communications has been thus far limited to implementation-based approaches, both, at the network and the UE sides. A study on enhancement for data collection for NR and ENDC (FS_NR_ENDC_data_collect) has examined the functional framework for RAN intelligence enabled by further enhancement of data collection through use cases, examples etc. and identify the potential standardization impacts on current NG-RAN nodes and interfaces. In SA WG2 AI/ML related study, a network functionality NWDAF (Network Data Analytics Function) was introduced in Rel-15 and has been enhanced in Rel-16 and Rel-17.

In this study, we explore the benefits of augmenting the air-interface with features enabling improved support of AI/ML based algorithms for enhanced performance and/or reduced complexity/overhead. Enhanced performance here depends on the use cases under consideration and could be, e.g., improved throughput, robustness, accuracy or reliability, etc.

Through studying a few carefully selected use cases, assessing their performance in comparison with traditional methods and the associated potential specification impacts that enable their solutions, this SI will lay the foundation for future air-interface use cases leveraging AI/ML techniques.

The goal is that sufficient use cases will be considered to enable the identification of a common AI/ML framework, including functional requirements of AI/ML architecture, which could be used in subsequent projects. The study should also identify areas where AI/ML could improve the performance of air-interface functions.

The study will serve identifying what is required for an adequate AI/ML model characterization and description establishing pertinent notation for discussions and subsequent evaluations. Various levels of collaboration between the gNB and UE are identified and considered.

Evaluations to exercise the attainable gains of AI/ML based techniques for the use cases under consideration will be carried out with the corresponding identification of KPIs with the goal to have a better understanding of the attainable gains and associated complexity requirements.

Finally, specification impact will be assessed in order to improve the overall understanding of what would be required to enable AI/ML techniques for the air-interface.

For the study on AI/ML for air-interface, the basic framework and principles agreed for FS_NR_ENDC_data_collect should be taken into consideration for possible applicability.

Study the 3GPP framework for AI/ML for air-interface corresponding to each target use case regarding aspects such as performance, complexity, and potential specification impact.

Use cases to focus on:
1> Initial set of use cases includes:
a) CSI feedback enhancement, e.g., overhead reduction, improved accuracy, prediction [RAN1]
b) Beam management, e.g., beam prediction in time, and/or spatial domain for overhead and latency reduction, beam selection accuracy improvement [RAN1]
c) Positioning accuracy enhancements for different scenarios including, e.g., those with heavy NLOS conditions [RAN1]
2> Finalize representative sub use cases for each use case for characterization and baseline performance evaluations
a) The AI/ML approaches for the selected sub use cases need to be diverse enough to support various requirements on the gNB-UE collaboration levels
the selection of use cases for this study solely targets the formulation of a framework to apply AI/ML to the air-interface for these and other use cases. The selection itself does not intend to provide any indication of the prospects of any future normative project.
AI/ML model, terminology and description to identify common and specific characteristics for framework investigations:
3> Characterize the defining stages of AI/ML related algorithms and associated complexity:
a) Model generation, e.g., model training (including input/output, pre-/post-process, online/offline as applicable), model validation, model testing, as applicable b) Inference operation, e.g., input/output, pre-/post-process, as applicable
4> Identify various levels of collaboration between UE and gNB pertinent to the selected use cases, e.g.,
a) No collaboration: implementation-based only AI/ML algorithms without information exchange [for comparison purposes]
b) Various levels of UE/gNB collaboration targeting at separate or joint ML operation.
5> Characterize lifecycle management of AI/ML model: e.g., model training, model deployment, model inference, model monitoring, model updating
6> Dataset(s) for training, validation, testing, and inference
7> Identify common notation and terminology for AI/ML related functions, procedures and interfaces
8> Note: Consider the work done for FS_NR_ENDC_data_collect when appropriate

For the use cases under consideration:
Evaluate performance benefits of AI/ML based algorithms for the agreed use cases in the final representative set:
a) Methodology based on statistical models, for link and system level simulations.
i. Extensions of 3GPP evaluation methodology for better suitability to AI/ML based techniques should be considered as needed.
ii. Whether field data are optionally needed to further assess the performance and robustness in real-world environments should be discussed as part of the study.
iii. Need for common assumptions in dataset construction for training, validation and test for the selected use cases.
iv. Consider adequate model training strategy, collaboration levels and associated implications
v. Consider agreed-upon base AI model(s) for calibration
vi. AI model description and training methodology used for evaluation should be reported for information and cross-checking purposes
b) KPIs: Determine the common KPIs and corresponding requirements for the AI/ML operations. Determine the use-case specific KPIs and benchmarks of the selected use-cases.
i. Performance, inference latency and computational complexity of AI/ML based algorithms should be compared to that of a state-of-the-art baseline
ii. Overhead, power consumption (including computational), memory storage, and hardware requirements (including for given processing delays) associated with enabling respective AI/ML scheme, as well as generalization capability should be considered.
Assess potential specification impact, specifically for the agreed use cases in the final representative set and for a common framework:
c) PHY layer aspects, e.g., (RAN1)
i. Consider aspects related to, e.g., the potential specification of the AI Model lifecycle management, and dataset construction for training, validation and test for the selected use cases
ii. Use case and collaboration level specific specification impact, such as new signalling, means for training and validation data assistance, assistance information, measurement, and feedback
d) Protocol aspects, e.g., (RAN2)-RAN2 only starts the work after there is sufficient progress on the use case study in RAN1
i. Consider aspects related to, e.g., capability indication, configuration and control procedures (training/inference), and management of data and AI/ML model, per RAN1 input
ii. Collaboration level specific specification impact per use case
e) Interoperability and testability aspects, e.g., (RAN4)-RAN4 only starts the work after there is sufficient progress on use case study in RAN1 and RAN2
i. Requirements and testing frameworks to validate AI/ML based performance enhancements and ensuring that UE and gNB with AI/ML meet or exceed the existing minimum requirements if applicable
ii. Consider the need and implications for AI/ML processing capabilities definition
specific AI/ML models are not expected to be specified and are left to implementation. User data privacy needs to be preserved.
The study on AI/ML for air interface is based on the current RAN architecture and new interfaces shall not be introduced.

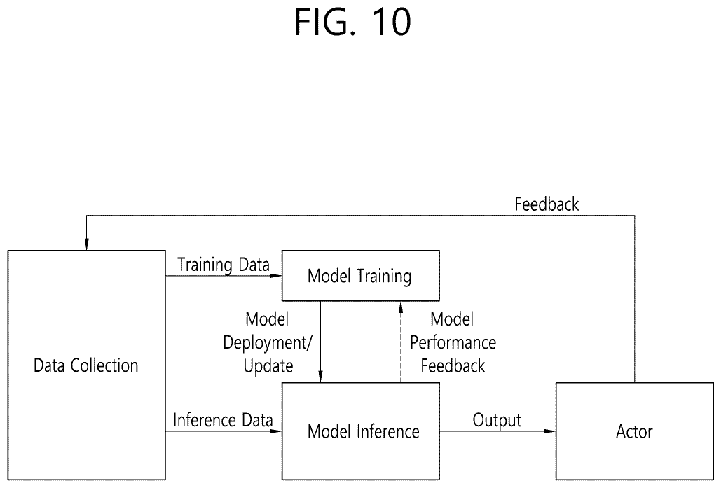

FIG. 10 shows an example of a Functional Framework for RAN Intelligence.

> Data Collection is a function that provides input data to Model training and Model inference functions. AI/ML algorithm specific data preparation (e.g., data pre-processing and cleaning, formatting, and transformation) is not carried out in the Data Collection function.

Examples of input data may include measurements from Ues or different network entities, feedback from Actor, output from an AI/ML model.
>> Training Data: Data needed as input for the AI/ML Model Training function.
>> Inference Data: Data needed as input for the AI/ML Model Inference function.
> Model Training is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required.
>> Model Deployment/Update: Used to initially deploy a trained, validated, and tested AI/ML model to the Model Inference function or to deliver an updated model to the Model Inference function.
> Model Inference is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required.
>> Output: The inference output of the AI/ML model produced by a Model Inference function.
>>> Note: Details of inference output are use case specific.
>> Model Performance Feedback: It may be used for monitoring the performance of the AI/ML model, when available.
> Actor is a function that receives the output from the Model Inference function and triggers or performs corresponding actions. The Actor may trigger actions directed to other entities or to itself.
>> Feedback: Information that may be needed to derive training data, inference data or to monitor the performance of the AI/ML Model and its impact to the network through updating of KPIs and performance counters.

Hereinafter, technical features related to Mobility Optimization are described.

Mobility management is the scheme to guarantee the service-continuity during the mobility by minimizing the call drops, RLFs, unnecessary handovers, and ping-pong. For the future high-frequency network, as the coverage of a single node decreases, the frequency for UE to handover between nodes becomes high, especially for high-mobility UE. In addition, for the applications characterized with the stringent QoS requirements such as reliability, latency etc., the QoE is sensitive to the handover performance, so that mobility management should avoid unsuccessful handover and reduce the latency during handover procedure. However, for the conventional method, it is challengeable for trial-and-error-based scheme to achieve nearly zero-failure handover. The unsuccessful handover cases are the main reason for packet dropping or extra delay during the mobility period, which is unexpected for the packet-drop-intolerant and low-latency applications. In addition, the effectiveness of adjustment based on feedback may be weak due to randomness and inconstancy of transmission environment. Besides the baseline case of mobility, areas of optimization for mobility include dual connectivity, CHO, and DAPS, which each has additional aspects to handle in the optimization of mobility.

Mobility aspects of SON that can be enhanced by the use of AI/ML include
Reduction of the probability of unintended events
UE Location/Mobility/Performance prediction
Traffic Steering

Reduction of the probability of unintended events associated with mobility.

Examples of such unintended events are:
Intra-system Too Late Handover: A radio link failure (RLF) occurs after the UE has stayed for a long period of time in the cell; the UE attempts to re-establish the radio link connection in a different cell.
Intra-system Too Early Handover: An RLF occurs shortly after a successful handover from a source cell to a target cell or a handover failure occurs during the handover procedure; the UE attempts to re-establish the radio link connection in the source cell.
Intra-system Handover to Wrong Cell: An RLF occurs shortly after a successful handover from a source cell to a target cell or a handover failure occurs during the handover procedure; the UE attempts to re-establish the radio link connection in a cell other than the source cell and the target cell.
Successful Handover: During a successful handover, there is underlying issue.

RAN Intelligence could observe multiple HO events with associated parameters, use this information to train its ML model and try to identify sets of parameters that lead to successful Hos and sets of parameters that lead to unintended events.

### UE Location/Mobility/Performance Prediction

Predicting UE's location is a key part for mobility optimisation, as many RRM actions related to mobility (e.g., selecting handover target cells) can benefit from the predicted UE location/trajectory. UE mobility prediction is also one key factor in the optimization of early data forwarding particularly for CHO. UE Performance prediction when the UE is served by certain cells is a key factor in determining which is the best mobility target for maximisation of efficiency and performance.

### Traffic Steering

Efficient resource handling can be achieved adjusting handover trigger points and selecting optimal combination of Pcell/PSCell/Scells to serve a user.

Existing traffic steering can also be improved by providing a RAN node with information related to mobility or dual connectivity.

For example, before initiating a handover, the source gNB could use feedbacks on UE performance collected for successful handovers occurred in the past and received from neighbouring gNBs.

Similarly, for the case of dual connectivity, before triggering the addition of a secondary gNB or triggering SN change, an eNB could use information (feedbacks) received in the past from the gNB for successfully completed SN Addition or SN Change procedures.

In the two reported examples, the source RAN node of a mobility event, or the RAN node acting as Master Node (a eNB for EN-DC, a gNB for NR-DC) can use feedbacks received from the other RAN node, as input to an AI/ML function supporting traffic related decisions (e.g., selection of target cell in case of mobility, selection of a PSCell/Scell(s) in the other case), so that future decisions can be optimized.

### Locations for AI/ML Model Training and AI/ML Model Inference

Considering the locations of AI/ML Model Training and AI/ML Model Inference for mobility solution, the following two options are considered:
The AI/ML Model Training function is deployed in OAM, while the Model Inference function resides within the RAN node
Both the AI/ML Model Training function and the AI/ML Model Inference function reside within the RAN node

Furthermore, for CU-DU split scenario, following option is possible:
AI/ML Model Training is located in CU-CP or OAM, and AI/ML Model Inference function is located in CU-CP
gNB is also allowed to continue model training based on AI/ML model trained in the OAM.

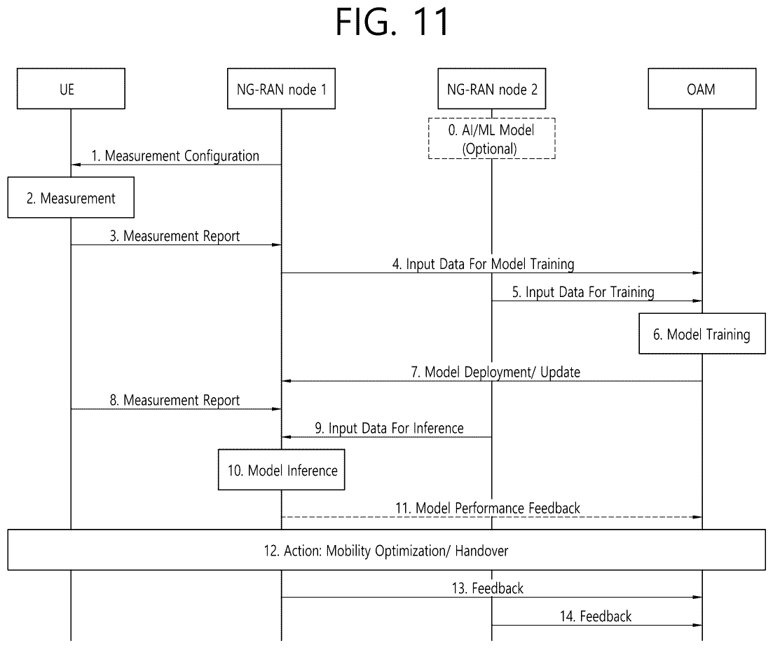

FIG. 11 shows an example of an AI/ML Model Training in OAM and AI/ML Model Inference in NG-RAN node.

Step 0. NG-RAN node 2 is assumed to optionally have an AI/ML model, which can generate required input such as resource status and utilization prediction/estimation etc.

Step 1. The NG-RAN node configures the measurement information on the UE side and sends configuration message to UE including configuration information.

Step 2. The UE collects the indicated measurement, e.g., UE measurements related to RSRP, RSRQ, SINR of serving cell and neighbouring cells.

Step 3. The UE sends measurement report message to NG-RAN node 1 including the required measurement.

Step 4. The NG-RAN node 1 sends the input data for training to OAM, where the input data for training includes the required input information from the NG-RAN node 1 and the measurement from UE.

Step 5. The NG-RAN node 2 sends the input data for training to OAM, where the input data for training includes the required input information from the NG-RAN node 2. If the NG-RAN node 2 executes the AI/ML model, the input data for training can include the corresponding inference result from the NG-RAN node 2.

Step 6. Model Training. Required measurements are leveraged to training AI/ML model for UE mobility optimization.

Step 7. OAM sends AI/ML Model Deployment Message to deploy the trained/updated AI/ML model into the NG-RAN node(s). The NG-RAN node can also continue model training based on the received AI/ML model from OAM.

Note: This step is out of RAN3 Rel-17 scope.

Step 8. The NG-RAN node 1 obtains the measurement report as inference data for UE mobility optimization.

Step 9. The NG-RAN node 1 obtains the input data for inference from the NG-RAN node 2 for UE mobility optimization, where the input data for inference includes the required input information from the NG-RAN node 2. If the NG-RAN node 2 executes the AI/ML model, the input data for inference can include the corresponding inference result from the NG-RAN node 2.

Step 10. Model Inference. Required measurements are leveraged into Model Inference to output the prediction, e.g., UE trajectory prediction, target cell prediction, target NG-RAN node prediction, etc.

Step 11. The NG-RAN 1 sends the model performance feedback to OAM if applicable.

Note: This step is out of RAN3 scope.

Step 12: According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node.

Step 13. The NG-RAN node 1 sends the feedback information to OAM.

Step 14. The NG-RAN node 2 sends the feedback information to OAM.

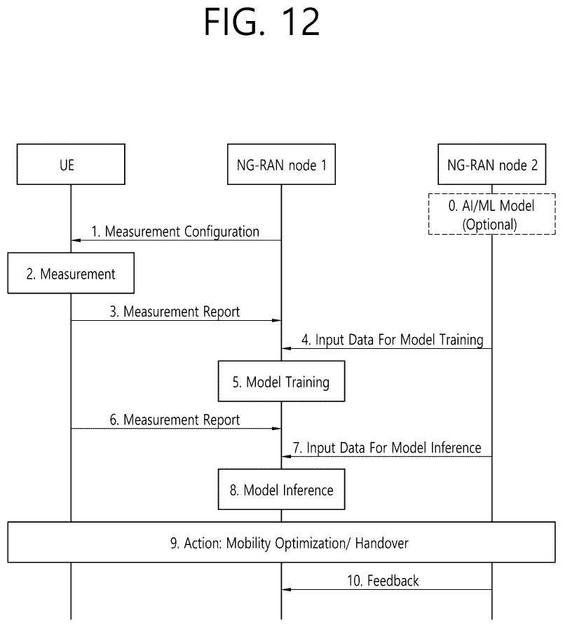

FIG. 12 shows an example of Model Training and Model Inference both located in RAN node.

Step 0. NG-RAN node 2 is assumed to optionally have an AI/ML model, which can generate required input such as resource status and utilization prediction/estimation etc.

Step 1. NG-RAN node1 configures the measurement information on the UE side and sends configuration message to UE including configuration information.

Step 2. UE collects the indicated measurement, e.g., UE measurements related to RSRP, RSRQ, SINR of serving cell and neighbouring cells.

Step 3. UE sends measurement report message to NG-RAN node1 including the required measurement.

Step 4. The NG-RAN node 1 obtains the input data for training from the NG-RAN node2, where the input data for training includes the required input information from the NG-RAN node 2. If the NG-RAN node 2 executes the AI/ML model, the input data for training can include the corresponding inference result from the NG-RAN node 2.

Step 5. Model training. Required measurements are leveraged to training AI/ML model for mobility optimization.

Step 6. NG-RAN node1 obtains the measurement report as inference data for real-time UE mobility optimization.

Step 7. The NG-RAN node 1 obtains the input data for inference from the NG-RAN node 2 for UE mobility optimization, where the input data for inference includes the required input information from the NG-RAN node 2. If the NG-RAN node 2 executes the AI/ML model, the input data for inference can include the corresponding inference result from the NG-RAN node 2.

Step 8. Model Inference. Required measurements are leveraged into Model Inference to output the prediction, including e.g., UE trajectory prediction, target cell prediction, target NG-RAN node prediction, etc.

Step 9: According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node.

Step 10. The NG-RAN node 2 sends feedback information after mobility optimization action to the NG-RAN node 1.

For example, UE mobility information for training purposes is only sent to gNBs that requested such information or when triggered.

### Input of AI/ML-based Mobility Optimization

The following data is required as input data for mobility optimization.

### From the UE:

UE location information (e.g., coordinates, serving cell ID, moving velocity) interpreted by gNB implementation when available.
Radio measurements related to serving cell and neighbouring cells associated with UE location information, e.g., RSRP, RSRQ, SINR.
UE Mobility History Information.

From the neighbouring RAN nodes:
UE's history information from neighbour
Position, QoS parameters and the performance information of historical HO-ed UE (e.g., loss rate, delay, etc.)
Current/predicted resource status
UE handovers in the past that were successful and unsuccessful, including too-early, too-late, or handover to wrong (sub-optimal) cell, based on existing SON/RLF report mechanism.

From the local node:
UE trajectory prediction
Current/predicted resource status
Current/predicted UE traffic

Output of AI/ML-based Mobility Optimization

AI/ML-based mobility optimization can generate following information as output:
UE trajectory prediction (Latitude, longitude, altitude, cell ID of UE over a future period of time)
Note: Whether the UE trajectory prediction is an external output to the node hosting the Model Inference function should be discussed during the normative work phase.
Estimated arrival probability in CHO and relevant confidence interval
Predicted handover target node, candidate cells in CHO, may together with the confidence of the predication
Priority, handover execution timing, predicted resource reservation time window for CHO.
UE traffic prediction (will be used by the RAN node internally and the details are left to normative work phase)
Model output validity time will be discussed during R18 normative work per inference output.

### Feedback of AI/ML-based Mobility Optimization

The following data is required as feedback data for mobility optimization.
QoS parameters such as throughput, packet delay of the handed-over UE, etc.
Resource status information updates from target NG-RAN.
Performance information from target NG-RAN. The details of performance information are to be discussed during normative work phase.

### Standard Impact

To improve the mobility decisions at a gNB (gNB-CU), a gNB can request mobility feedback from a neighbouring node. Details of the procedure will be determined during the normative phase.

If existing UE measurements are needed by a gNB for AI/ML-based mobility optimization, RAN3 shall reuse the existing framework (including MDT and RRM measurements). Whether new UE measurements are needed is left to normative phase based on the use case description.

MDT procedure enhancements should be discussed during the normative phase.

### Potential Xn Interface Impact:

Predicted resource status info and performance info from candidate target NG-RAN node to source NG-RAN node
New signaling procedure or existing procedure to retrieve input information via Xn interface.
New signaling procedure or existing procedure to retrieve feedback information via Xn interface.

Hereinafter, technical features related to AI and ML are described.

Artificial Intelligence (AI)/Machine Learning (ML) is being used in a range of application domains across industry sectors, realizing significant productivity gains. In particular, in mobile communications systems, mobile devices (e.g. smartphones, smart vehicles, UAVs, mobile robots) are increasingly replacing conventional algorithms (e.g. speech recognition, machine translation, image recognition, video processing, user behaviour prediction) with AI/ML models to enable applications like enhanced photography, intelligent personal assistants, VR/AR, video gaming, video analytics, personalized shopping recommendation, autonomous driving/navigation, smart home appliances, mobile robotics, mobile medicals, as well as mobile finance.

Artificial Intelligence (AI) is the science and engineering to build intelligent machines capable of carrying out tasks as humans do.

### Deep Neural Network

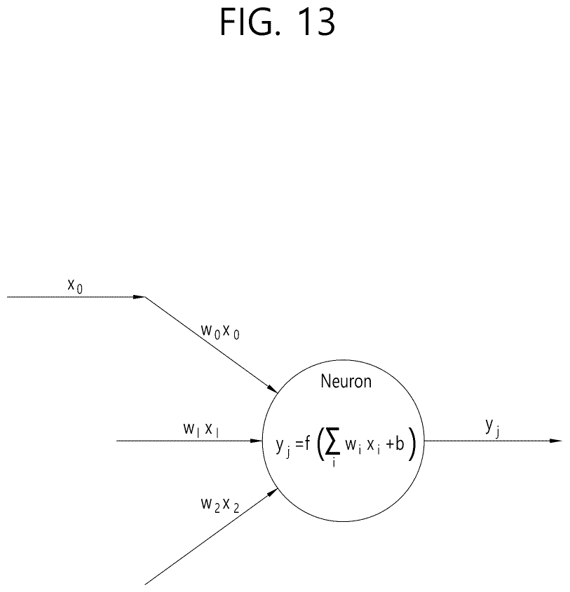

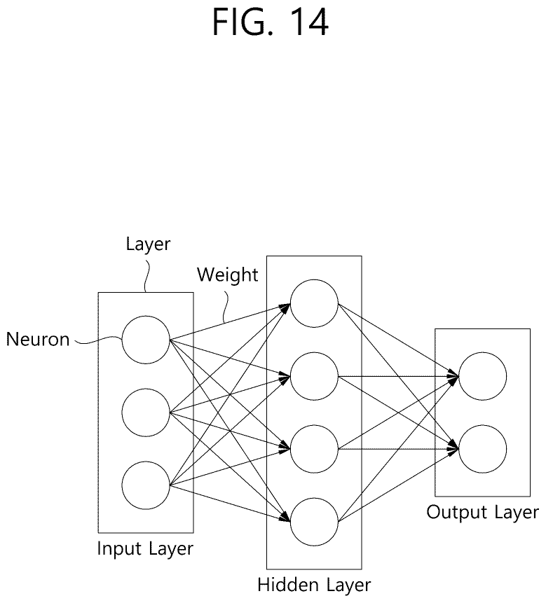

FIGS. 13 and 14 show an example of an architecture of neuron and neural network.

Within the ML field, there is an area that is often referred to as brain-inspired computation, which is a program aiming to emulate some aspects of how we understand the brain to operate. Since it is believed that the main computational elements a human brain are 86 billion neurons, the two subareas of brain-inspired computation are both inspired by the architecture of a neuron, as shown in FIG. 13.

Compared to spiking computing approaches, the more popular ML approaches are using “neural network” as the model. Neural networks (NN) take their inspiration from the notion that a neuron's computation involves a weighted sum of the input values. But instead of simply outputting the weighted sum, a NN applies a nonlinear function to generate an output only if the inputs cross some threshold, as shown in FIG. 13.

FIG. 14 shows a diagrammatic picture of a computational neural network. The neurons in the input layer receive some values and propagate them to the neurons in the middle layer of the network, which is also called a “hidden layer”. The weighted sums from one or more hidden layers are ultimately propagated to the output layer, which presents the final outputs of the network.

Neural networks having more than three layers, i.e., more than one hidden layer are called deep neural networks (DNN). In contrast to the conventional shallow-structured NN architectures, DNNs, also referred to as deep learning, made amazing breakthroughs since 2010s in many essential application areas because they can achieve human-level accuracy or even exceed human accuracy. Deep learning techniques use supervised and/or unsupervised strategies to automatically learn hierarchical representations in deep architectures for classification. With a large number of hidden layers, the superior performance of DNNs comes from its ability to extract high-level features from raw sensory data after using statistical learning over a large amount of data to obtain an effective representation of an input space. In recent years, thanks to the big data obtained from the real world, the rapidly increased computation capacity and continuously-evolved algorithms, DNNs have become the most popular ML models for many AI applications.

### Training and Inference

Training is a process in which a AI/ML model learns to perform its given tasks, more specifically, by optimizing the value of the weights in the DNN. A DNN is trained by inputting a training set, which are often correctly-labelled training samples. Taking image classification for instance, the training set includes correctly-classified images. When training a network, the weights are usually updated using a hill-climbing optimization process called gradient descent. The gradient indicates how the weights should change in order to reduce the loss (the gap between the correct outputs and the outputs computed by the DNN based on its current weights). The training process is repeated iteratively to continuously reduce the overall loss. Until the loss is below a predefined threshold, the DNN with high precision is obtained.

There are multiple ways to train the network for different targets. The introduced above is supervised learning which uses the labelled training samples to find the correct outputs for a task. Unsupervised learning uses the unlabelled training samples to find the structure or clusters in the data. Reinforcement learning can be used to output what action the agent should take next to maximize expected rewards. Transfer learning is to adjust the previously-trained weights (e.g. weights in a global model) using a new training set, which is used for a faster or more accurate training for a personalized model.

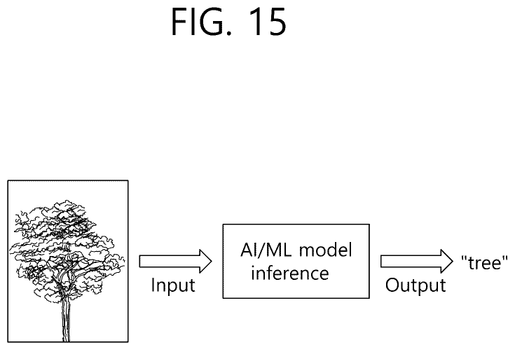

FIG. 15 shows an example of an AI/ML inference.

After a DNN is trained, it can perform its task by computing the output of the network using the weights determined during the training process, which is referred to as inference. In the model inference process, the inputs from the real world are passed through the DNN. Then the prediction for the task is output, as shown in FIG. 15. For instance, the inputs can be pixels of an image, sampled amplitudes of an audio wave or the numerical representation of the state of some system or game. Correspondingly, the outputs of the network can be a probability that an image contains a particular object, the probability that an audio sequence contains a particular word or a bounding box in an image around an object or the proposed action that should be taken.

The performance of DNNs is gained at the cost of high computational complexity. Hence more efficient compute engines are often used, e.g. graphics processing units (GPU) and network processing units (NPU). Compared to the inference which only involves the feedforward process, the training often requires more computation and storage resources because it involves also the backpropagation process.

### Widely-Used DNN Models and Algorithms

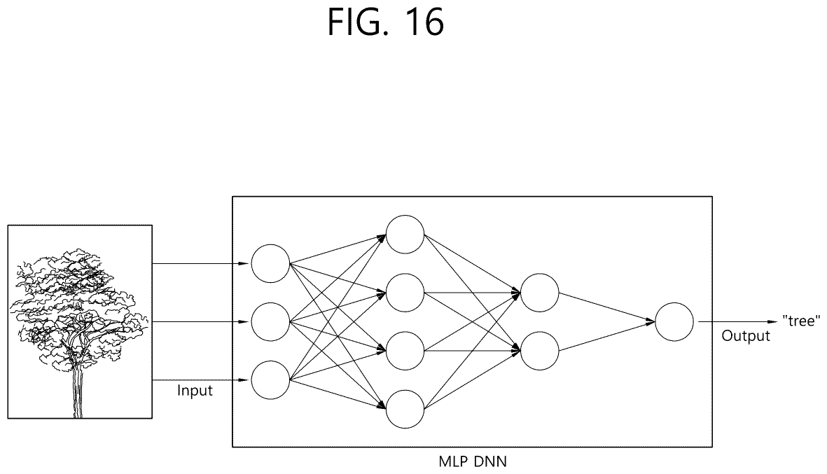

FIG. 16 shows an example of an MLP DNN model.

Many DNN models have been developed over the past two decades. Each of these models has a different “network architecture” in terms of number of layers, layer types, layer shapes (i.e., filter size, number of channels and filters), and connections between layers. FIG. 16 presents three popular structures of DNNs: multilayer perceptrons (MLPs), convolution neural networks (CNNs), and recurrent neural networks (RNNs). Multilayer perceptrons (MLP) model is the most basic DNN, which is composed of a series of fully connected layers. In a fully connected layer, all outputs are connected to all inputs, as shown in FIG. 16. Hence MLP requires a significant amount of storage and computation.

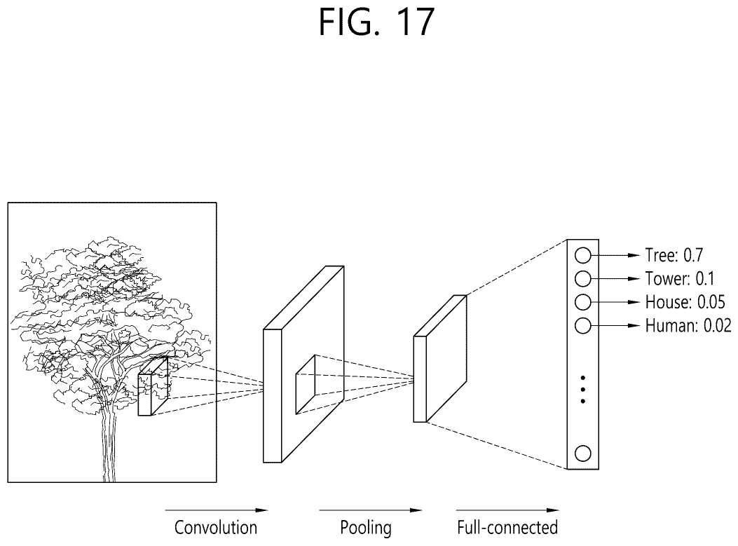

FIG. 17 shows an example of a CNN model.

An approach to limiting the number of weights that contribute to an output is to calculate the output only using a function of a fixed-size window of inputs. An extremely popular window-based DNN model uses a convolution operation to structure the computation, hence is named as convolution neural network (CNN). A CNN is composed of multiple convolutional layers, as shown in FIG. 17. Applying various convolutional filters, CNN models can capture the high-level representation of the input data, making it popular for image classification and speech recognition tasks.

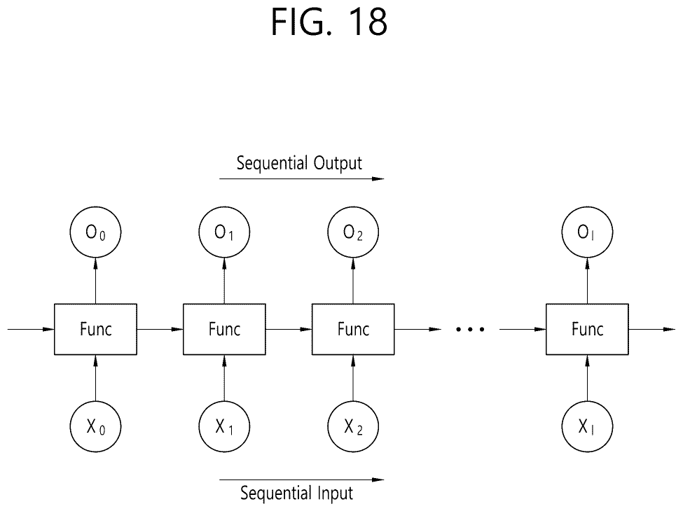

FIG. 18 shows an example of an RNN model.

Recurrent neural network (RNN) models are another type of DNNs, which use sequential data feeding. The input of RNN consists of the current input and the previous samples. Each neuron in an RNN owns an internal memory that keeps the information of the computation from the previous samples. As shown in FIG. 18, the basic unit of RNN is called cell, and further, each cell consists of layers and a series of cells enables the sequential processing of RNN models. RNN models have been widely used in the natural language processing task on mobile devices, e.g., language modelling, machine translation, question answering, word embedding, and document classification.

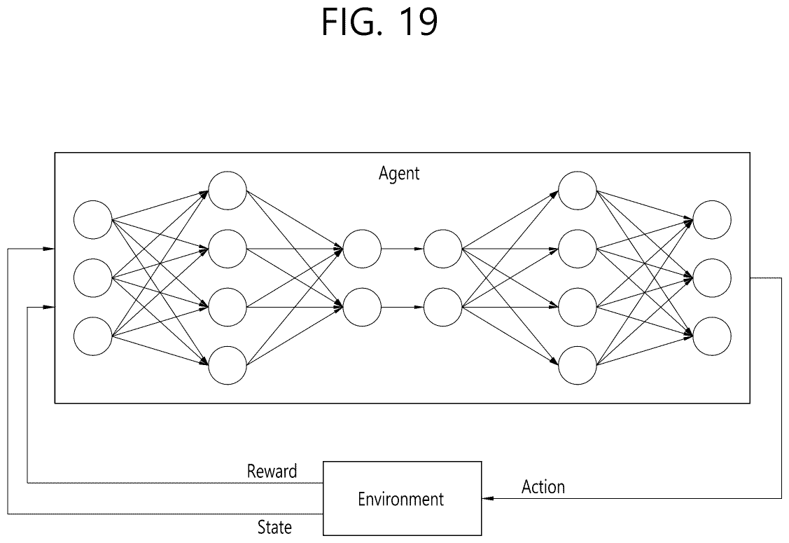

FIG. 19 shows an example of Reinforcement learning.

Deep reinforcement learning (DRL) is not another DNN model. It is composed of DNNs and reinforcement learning. As illustrated in FIG. 19, the goal of DRL is to create an intelligent agent that can perform efficient policies to maximize the rewards of long-term tasks with controllable actions. The typical application of DRL is to solve various scheduling problems, such as decision problems in games, rate selection of video transmission, and so on.

Hereinafter, technical features related to measurement report are described. Parts of section 5.5.4 and section 5.5.5 of 3GPP TS 38.331 v17.0.0 may be referred.

### Measurement Report Triggering

If AS security has been activated successfully, the UE shall:
1> for each measId included in the measIdList within VarMeasConfig:
2> if the corresponding reportConfig includes a reportType set to eventTriggered or periodical:
3> if the corresponding measObject concerns NR:
4> if the corresponding reportConfig includes measRSSI-ReportConfig:
5> consider the resource indicated by the rmtc-Config on the associated frequency to be applicable;
4> if the eventA1 or eventA2 is configured in the corresponding reportConfig:
5> consider only the serving cell to be applicable;
4> if the eventA3 or eventA5 is configured in the corresponding reportConfig:
5> if a serving cell is associated with a measObjectNR and neighbours are associated with another measObjectNR, consider any serving cell associated with the other measObjectNR to be a neighbouring cell as well;
4> if corresponding reportConfig includes reportType set to periodical; or
4> for measurement events other than eventA1 or eventA2:
5> if useAllowedCellList is set to true:
6> consider any neighbouring cell detected based on parameters in the associated measObjectNR to be applicable when the concerned cell is included in the allowedCellsToAddModList defined within the VarMeasConfig for this measId;
5> else:
6> consider any neighbouring cell detected based on parameters in the associated measObjectNR to be applicable when the concerned cell is not included in the excludedCellsToAddModList defined within the VarMeasConfig for this measId;
3> else if the corresponding measObject concerns E-UTRA:
4> if eventB1 or eventB2 is configured in the corresponding reportConfig:
5> consider a serving cell, if any, on the associated E-UTRA frequency as neighbour cell;
4> consider any neighbouring cell detected on the associated frequency to be applicable when the concerned cell is not included in the excludedCellsToAddModListEUTRAN defined within the VarMeasConfig for this measId;
3> else if the corresponding measObject concerns UTRA-FDD:
4> if eventB1-UTRA-FDD or eventB2-UTRA-FDD is configured in the corresponding reportConfig; or
4> if corresponding reportConfig includes reportType set to periodical:
5> consider a neighbouring cell on the associated frequency to be applicable when the concerned cell is included in the cellsToAddModList defined within the VarMeasConfig for this measId;
3> else if the corresponding measObject concerns L2 U2N Relay UE:
4> if eventY1-Relay is configured in the corresponding reportConfig; or
4> if corresponding reportConfig includes reportType set to periodical:
5> consider any L2 U2N Relay UE detected on the associated frequency to be applicable for this measId;
2> else if the corresponding reportConfig includes a reportType set to reportCGI:
3> consider the cell detected on the associated measObject which has a physical cell identity matching the value of the cellForWhichToReportCGI included in the corresponding reportConfig within the VarMeasConfig to be applicable;
2> else if the corresponding reportConfig includes a reportType set to reportSFTD:
3> if the corresponding measObject concerns NR:
4> if the reportSFTD-Meas is set to true:
5> consider the NR PSCell to be applicable;
4> else if the reportSFTD-NeighMeas is included:
5> if cellsForWhichToReportSFTD is configured in the corresponding reportConfig:
6> consider any NR neighbouring cell detected on the associated measObjectNR which has a physical cell identity that is included in the cellsForWhichToReportSFTD to be applicable;
5> else:
6> consider up to 3 strongest NR neighbouring cells detected based on parameters in the associated measObjectNR to be applicable when the concerned cells are not included in the excludedCellsToAddModList defined within the VarMeasConfig for this measId;
3> else if the corresponding measObject concerns E-UTRA:
4> if the reportSFTD-Meas is set to true:
5> consider the E-UTRA PSCell to be applicable;
2> else if the corresponding reportConfig includes a reportType set to cli-Periodical or cli-EventTriggered:
3> consider all CLI measurement resources included in the corresponding measObject to be applicable;
2> else if the corresponding reportConfig includes a reportType set to rxTxPeriodical:
3> consider all Rx-Tx time difference measurement resources included in the corresponding measObject to be applicable;
2> if the corresponding reportConfig concerns the reporting for NR sidelink communication (i.e. reportConfigNR-SL):
3> consider the transmission resource pools indicated by the tx-PoolMeasToAddModList defined within the VarMeasConfig for this measId to be applicable;
2> if the reportType is set to eventTriggered and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
3> include a measurement reporting entry within the VarMeasReportList for this measId;
3> set the numberOfReportsSent defined within the VarMeasReportList for this measId to 0;
3> include the concerned cell(s) in the cellsTriggeredList defined within the VarMeasReportList for this measId;
3> if useT312 is set to true in reportConfig for this event:
4> if T310 for the corresponding SpCell is running; and
4> if T312 is not running for corresponding SpCell:
5> start timer T312 for the corresponding SpCell with the value of T312 configured in the corresponding measObjectNR;
3> initiate the measurement reporting procedure;
2> else if the reportType is set to eventTriggered and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
3> set the numberOfReportsSent defined within the VarMeasReportList for this measId to 0;
3> include the concerned cell(s) in the cellsTriggeredList defined within the VarMeasReportList for this measId;
3> if useT312 is set to true in reportConfig for this event:
4> if T310 for the corresponding SpCell is running; and
4> if T312 is not running for corresponding SpCell:
5> start timer T312 for the corresponding SpCell with the value of T312 configured in the corresponding measObjectNR;
3> initiate the measurement reporting procedure;
2> else if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
3> remove the concerned cell(s) in the cellsTriggeredList defined within the VarMeasReportList for this measId;
3> if reportOnLeave is set to true for the corresponding reporting configuration:
4> initiate the measurement reporting procedure;
3> if the cellsTriggeredList defined within the VarMeasReportList for this measId is empty:
4> remove the measurement reporting entry within the VarMeasReportList for this measId;
4> stop the periodical reporting timer for this measId, if running;
2> if the reportType is set to eventTriggered and if the entry condition applicable for this event, i.e. the event corresponding with the eventId of the corresponding reportConfig within VarMeasConfig, is fulfilled for one or more applicable L2 U2N Relay UEs for all measurements after layer 3 filtering taken during timeToTrigger defined for this event within the VarMeasConfig, while the VarMeasReportList does not include a measurement reporting entry for this measId (a first L2 U2N Relay UE triggers the event):
3> include a measurement reporting entry within the VarMeasReportList for this

measId;
3> set the numberOfReportsSent defined within the VarMeasReportList for this measId to 0;
3> include the concerned L2 U2N Relay UE(s) in the relaysTriggeredList defined within the VarMeasReportList for this measId;
3> initiate the measurement reporting procedure;
2> else if the reportType is set to eventTriggered and if the entry condition applicable for this event, i.e. the event corresponding with the eventId of the corresponding reportConfig within VarMeasConfig, is fulfilled for one or more applicable L2 U2N Relay UEs not included in the relaysTriggeredList for all measurements after layer 3 filtering taken during timeToTrigger defined for this event within the VarMeasConfig (a subsequent L2 U2N Relay UE triggers the event):
3> set the numberOfReportsSent defined within the VarMeasReportList for this measId to 0;
3> include the concerned L2 U2N Relay UE(s) in the relaysTriggeredList defined within the VarMeasReportList for this measId;
3> initiate the measurement reporting procedure;
2> else if the reportType is set to eventTriggered and if the leaving condition applicable for this event is fulfilled for one or more of the L2 U2N Relay UEs included in the relaysTriggeredList defined within the VarMeasReportList for this measId for all measurements after layer 3 filtering taken during timeToTrigger defined within the VarMeasConfig for this event:
3> remove the concerned L2 U2N Relay UE(s) in the relaysTriggeredList defined within the VarMeasReportList for this measId;
3> if reportOnLeave is set to true for the corresponding reporting configuration: 4> initiate the measurement reporting procedure;
3> if the relaysTriggeredList defined within the VarMeasReportList for this measId is empty:
4> remove the measurement reporting entry within the VarMeasReportList for this measId;
4> stop the periodical reporting timer for this measId, if running;
2> else if the reportType is set to eventTriggered and if the entry condition applicable for this event, i.e. the event corresponding with the eventId of the corresponding reportConfig within VarMeasConfig, is fulfilled for one or more applicable transmission resource pools for all measurements taken during timeToTrigger defined for this event within the VarMeasConfig, while the VarMeasReportList does not include an measurement reporting entry for this measId (a first transmission resource pool triggers the event):
3> include a measurement reporting entry within the VarMeasReportList for this measId;
3> set the numberOfReportsSent defined within the VarMeasReportList for this measId to 0;
3> include the concerned transmission resource pool(s) in the poolsTriggeredList defined within the VarMeasReportList for this measId;
3> initiate the measurement reporting procedure;
2> else if the reportType is set to eventTriggered and if the entry condition applicable for this event, i.e. the event corresponding with the eventId of the corresponding reportConfig within VarMeasConfig, is fulfilled for one or more applicable transmission resource pools not included in the poolsTriggeredList for all measurements taken during timeToTrigger defined for this event within the VarMeasConfig (a subsequent transmission resource pool triggers the event):
3> set the numberOfReportsSent defined within the VarMeasReportList for this measId to 0;
3> include the concerned transmission resource pool(s) in the poolsTriggeredList defined within the VarMeasReportList for this measId;
3> initiate the measurement reporting procedure;
2> else if the reportType is set to eventTriggered and if the leaving condition applicable for this event is fulfilled for one or more applicable transmission resource pools included in the poolsTriggeredList defined within the VarMeasReportList for this measId for all measurements taken during timeToTrigger defined within the VarMeasConfig for this event:
3> remove the concerned transmission resource pool(s) in the poolsTriggeredList defined within the VarMeasReportList for this measId;
3> if the poolsTriggeredList defined within the VarMeasReportList for this measId is empty:
4> remove the measurement reporting entry within the VarMeasReportList for this measId;
4> stop the periodical reporting timer for this measId, if running
2> else if the reportType is set to eventTriggered and if the eventId is set to eventDI and if the entering condition applicable for this event, i.e. the event corresponding with the eventId of the corresponding reportConfig within VarMeasConfig, is fulfilled during timeToTrigger defined within the VarMeasConfig for this event:
3> include a measurement reporting entry within the VarMeasReportList for this measId;
3> set the numberOfReportsSent defined within the VarMeasReportList for this measId to 0;
3> initiate the measurement reporting procedure;
2> if reportType is set to periodical and if a (first) measurement result is available:
3> include a measurement reporting entry within the VarMeasReportList for this measId;
3> set the numberOfReportsSent defined within the VarMeasReportList for this measId to 0;
3> if the corresponding reportConfig includes measRSSI-ReportConfig:
4> initiate the measurement reporting procedure immediately when RSSI sample values are reported by the physical layer after the first L1 measurement duration;
3> else if the corresponding reportConfig includes the ul-DelayValueConfig:
4> initiate the measurement reporting procedure, immediately after a first measurement result is provided from lower layers of the associated DRB identity;
3> else if the corresponding reportConfig includes the ul-ExcessDelayConfig:
4> initiate the measurement reporting procedure, immediately after a first measurement result is provided from lower layers of the associated DRB identity (ies) according to the configured threshold per DRB identity (ies);
3> else if the reportAmount exceeds 1:
4> initiate the measurement reporting procedure, immediately after the quantity to be reported becomes available for the NR SpCell or for the serving L2 U2N Relay UE (if the UE is a L2 U2N Remote UE);
3> else (i.e. the reportAmount is equal to 1):
4> initiate the measurement reporting procedure, immediately after the quantity to be reported becomes available for the NR SpCell and for the strongest cell among the applicable cells, or for the NR SpCell and for the strongest L2 U2N Relay UEs among the applicable L2 U2N Relay UEs; or initiate the measurement reporting procedure, immediately after the quantity to be reported becomes available for the serving L2 U2N Relay UE and for the strongest cell among the applicable cells (if the UE is a L2 U2N Remote UE);
2> if, in case the corresponding reportConfig concerns the reporting for NR sidelink communication, reportType is set to periodical and if a (first) measurement result is available:
3> include a measurement reporting entry within the VarMeasReportList for this measId;
3> set the numberOfReportsSent defined within the VarMeasReportList for this measId to 0;
3> initiate the measurement reporting procedure, immediately after the quantity to be reported becomes available for the NR SpCell and CBR measurement results become available;
2> if the reportType is set to cli-EventTriggered and if the entry condition applicable for this event, i.e. the event corresponding with the eventId of the corresponding reportConfig within VarMeasConfig, is fulfilled for one or more applicable CLI measurement resources for all measurements after layer 3 filtering taken during timeToTrigger defined for this event within the VarMeasConfig, while the VarMeasReportList does not include a measurement reporting entry for this measId (a first CLI measurement resource triggers the event):
3> include a measurement reporting entry within the VarMeasReportList for this measId;
3> set the numberOfReportsSent defined within the VarMeasReportList for this measId to 0;
3> include the concerned CLI measurement resource(s) in the cli-TriggeredList defined within the VarMeasReportList for this measId;
3> initiate the measurement reporting procedure;
2> else if the reportType is set to cli-EventTriggered and if the entry condition applicable for this event, i.e. the event corresponding with the eventId of the corresponding reportConfig within VarMeasConfig, is fulfilled for one or more CLI measurement resources not included in the cli-TriggeredList for all measurements after layer 3 filtering taken during timeToTrigger defined for this event within the VarMeasConfig (a subsequent CLI measurement resource triggers the event):
3> set the numberOfReportsSent defined within the VarMeasReportList for this measId to 0;
3> include the concerned CLI measurement resource(s) in the cli-TriggeredList defined within the VarMeasReportList for this measId;
3> initiate the measurement reporting procedure;
2> else if the reportType is set to cli-EventTriggered and if the leaving condition applicable for this event is fulfilled for one or more of the CLI measurement resources included in the cli-TriggeredList defined within the VarMeasReportList for this measId for all measurements after layer 3 filtering taken during timeToTrigger defined within the VarMeasConfig for this event:
3> remove the concerned CLI measurement resource(s) in the cli-TriggeredList defined within the VarMeasReportList for this measId;
3> if reportOnLeave is set to true for the corresponding reporting configuration:
4> initiate the measurement reporting procedure;
3> if the cli-TriggeredList defined within the VarMeasReportList for this measId is empty:
4> remove the measurement reporting entry within the VarMeasReportList for this measId;
4> stop the periodical reporting timer for this measId, if running;
2> if reportType is set to cli-Periodical and if a (first) measurement result is available:
3> include a measurement reporting entry within the VarMeasReportList for this measId;
3> set the numberOfReportsSent defined within the VarMeasReportList for this measId to 0;
3> initiate the measurement reporting procedure, immediately after the quantity to be reported becomes available for at least one CLI measurement resource;
2> if reportType is set to rxTxPeriodical and if a (first) measurement result is available:
3> include a measurement reporting entry within the VarMeasReportList for this measId;
3> set the numberOfReportsSent defined within the VarMeasReportList for this measId to 0;
3> initiate the measurement reporting procedure;
2> upon expiry of the periodical reporting timer for this measId:
3> initiate the measurement reporting procedure.
2> if the corresponding reportConfig includes a reportType is set to reportSFTD:
3> if the corresponding measObject concerns NR:
4> if the drx-SFTD-NeighMeas is included:
5> if the quantity to be reported becomes available for each requested pair of PCell and NR cell:
6> stop timer T322;
6> initiate the measurement reporting procedure;
4> else
5> initiate the measurement reporting procedure, immediately after the quantity to be reported becomes available for each requested pair of PCell and NR cell or the maximal measurement reporting delay;
3> else if the corresponding measObject concerns E-UTRA:
4> initiate the measurement reporting procedure, immediately after the quantity to be reported becomes available for the pair of PCell and E-UTRA PSCell or the maximal measurement reporting delay;
2> if reportType is set to reportCGI:
3> if the UE acquired the SIB1 or SystemInformationBlockType1 for the requested cell; or
3> if the UE detects that the requested NR cell is not transmitting SIB1 (see TS 38.213 [13], clause 13):
4> stop timer T321;
4> include a measurement reporting entry within the VarMeasReportList for this measId;
4> set the numberOfReportsSent defined within the VarMeasReportList for this measId to 0;
4> initiate the measurement reporting procedure;
2> upon the expiry of T321 for this measId:
3> include a measurement reporting entry within the VarMeasReportList for this measId;
3> set the numberOfReportsSent defined within the VarMeasReportList for this measId to 0;
3> initiate the measurement reporting procedure.
2> upon the expiry of T322 for this measId:
3> initiate the measurement reporting procedure.

Events are as follows:
Event A1: Serving becomes better than threshold
Event A2: Serving becomes worse than threshold
Event A3: Neighbour becomes offset better than SpCell
Event A4: Neighbour becomes better than threshold
Event A5: SpCell becomes worse than threshold1 and neighbour becomes better than threshold2
Event A6: Neighbour becomes offset better than SCell
Event B1: Inter RAT neighbour becomes better than threshold
Event B2: PCell becomes worse than threshold1 and inter RAT neighbour becomes better than threshold2
Event I1: Interference becomes higher than threshold
Event C1: The NR sidelink channel busy ratio is above a threshold
Event C2: The NR sidelink channel busy ratio is below a threshold
Event X1: Serving L2 U2N Relay UE becomes worse than threshold1 and NR Cell becomes better than threshold2
Event X2: Serving L2 U2N Relay UE becomes worse than threshold
Event Y1: PCell becomes worse than threshold1 and candidate L2 U2N Relay UE becomes better than threshold2
Event Y2: Candidate L2 U2N Relay UE becomes better than threshold

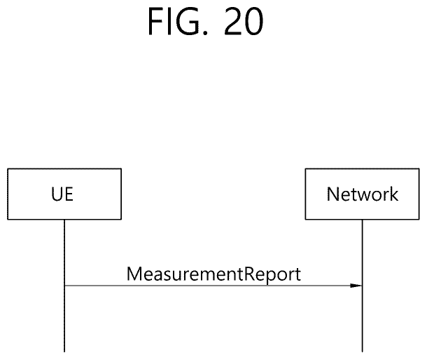

FIG. 20 shows an example of measurement reporting.

The purpose of this procedure is to transfer measurement results from the UE to the network. The UE shall initiate this procedure only after successful AS security activation.

For the measId for which the measurement reporting procedure was triggered, the UE shall set the measResults within the MeasurementReport message as follows:
1> set the measId to the measurement identity that triggered the measurement reporting;
1> for each serving cell configured with serving CellMO:
2> if the reportConfig associated with the measId that triggered the measurement reporting includes rsType:
3> if the serving cell measurements based on the rsType included in the reportConfig that triggered the measurement report are available:
4> set the measResultServingCell within measResultServingMOList to include RSRP, RSRQ and the available SINR of the serving cell, derived based on the rsType included in the reportConfig that triggered the measurement report;
2> else:
3> if SSB based serving cell measurements are available:
4> set the measResultServingCell within measResultServingMOList to include RSRP, RSRQ and the available SINR of the serving cell, derived based on SSB;
3> else if CSI-RS based serving cell measurements are available:
4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
2> for each serving cell configured with servingCellMO, include beam measurement information according to the associated reportConfig;
1> if the reportConfig associated with the measId that triggered the measurement reporting includes reportAddNeighMeas:
2> for each measObjectId referenced in the measIdList which is also referenced with servingCellMO, other than the measObjectId corresponding with the measId that triggered the measurement reporting:
3> if the measObjectNR indicated by the serving CellMO includes the RS resource configuration corresponding to the rsType indicated in the reportConfig:
4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
4> if the reportConfig associated with the measId that triggered the measurement reporting includes reportQuantityRS-Indexes and maxNrofRS-IndexesToReport:
5> for each best non-serving cell included in the measurement report:
6> include beam measurement information according to the associated reportConfig;

### Reporting of Beam Measurement Information

For beam measurement information to be included in a measurement report the UE shall:
1> if reportType is set to eventTriggered:
2> consider the trigger quantity as the sorting quantity if available, otherwise RSRP as sorting quantity if available, otherwise RSRQ as sorting quantity if available, otherwise SINR as sorting quantity;
1> if reportType is set to periodical:
2> if a single reporting quantity is set to true in reportQuantityRS-Indexes;
3> consider the configured single quantity as the sorting quantity;
2> else:
3> if rsrp is set to true;
4> consider RSRP as the sorting quantity;
3> else:
4> consider RSRQ as the sorting quantity;
1> set rsIndexResults to include up to maxNrofRS-IndexesToReport SS/PBCH block indexes or CSI-RS indexes in order of decreasing sorting quantity as follows:
2> if the measurement information to be included is based on SS/PBCH block:
3> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;
3> if includeBeamMeasurements is set to true, include the SS/PBCH based measurement results for the quantities in reportQuantityRS-Indexes for each SS/PBCH block index;
2> else if the beam measurement information to be included is based on CSI-RS:
3> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;
3> if includeBeamMeasurements is set to true, include the CSI-RS based measurement results for the quantities in reportQuantityRS-Indexes for each CSI-RS index. Hereinafter, technical features related to conditional reconfiguration are described.

Parts of section 5.3.5.13 of 3GPP TS 38.331 v17.0.0 may be referred.

The network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

The UE performs the following actions based on a received ConditionalReconfiguration IE:
1> if the ConditionalReconfiguration contains the condReconfigToRemoveList:
2> perform conditional reconfiguration removal procedure;
1> if the ConditionalReconfiguration contains the condReconfigToAddModList:
2> perform conditional reconfiguration addition/modification;
Conditional reconfiguration removal

The UE shall:
1> for each condReconfigId value included in the condReconfigToRemoveList that is part of the current UE conditional reconfiguration in VarConditionalReconfig:
2> remove the entry with the matching condReconfigld from the VarConditionalReconfig;

The UE does not consider the message as erroneous if the condReconfigToRemoveList includes any condReconfigld value that is not part of the current UE configuration.

### Conditional Reconfiguration Addition/Modification

For each condReconfigId received in the condReconfigToAddModList IE the UE shall:
1> if an entry with the matching condReconfigId exists in the condReconfigToAddModList within the VarConditionalReconfig:
2> if the entry in condReconfigToAddModList includes an condExecutionCond or condExecutionCondSCG;
3> replace condExecutionCond or condExecutionCondSCG within the VarConditionalReconfig with the value received for this condReconfigld;
2> if the entry in condReconfigToAddModList includes an condRRCReconfig;
3> replace condRRCReconfig within the VarConditionalReconfig with the value received for this condReconfigld;
1> else:
2> add a new entry for this condReconfigld within the VarConditionalReconfig;
1> perform conditional reconfiguration evaluation;

### Conditional Reconfiguration Evaluation

The UE shall:
1> for each condReconfigId within the VarConditionalReconfig:
2> if the RRCReconfiguration within condRRCReconfig includes the masterCellGroup including the reconfigurationWithSync, consider the cell which has a physical cell identity matching the value indicated in the Serving CellConfigCommon included in the reconfiguration WithSync within the masterCellGroup in the received condRRCReconfig to be applicable cell;
2> if the RRCReconfiguration within condRRCReconfig includes the secondaryCellGroup including the reconfigurationWithSync, consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedures, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig via SRB1:
4> in the remainder of the procedures, consider each measId indicated in the condExecutionCond as a measId in the VarMeasConfig associated with the SCG measConfig;
3> otherwise:
4> in the remainder of the procedures, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventT1, and if the entry condition(s) applicable for this event associated with the condReconfigld, i.e. the event corresponding with the condEventld(s) of the corresponding condTriggerConfig within VarConditionalReconfig, is fulfilled for the applicable cells; or
3> if the condEventId is associated with condEventD1, and if the entry condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition(s) applicable for this event associated with the condReconfigld, i.e. the event corresponding with the condEventId(s) of the corresponding condTriggerConfig within VarConditionalReconfig, is fulfilled for the applicable cells; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution;

Up to 2 MeasId can be configured for each condReconfigld. The conditional reconfiguration event of the 2 MeasId may have the same or different event conditions, triggering quantity, time to trigger, and triggering threshold.

### Conditional Reconfiguration Evaluation of SN Initiated Inter-SN CPC for EN-DC

The UE shall:
1> for each condReconfigId within the VarConditionalReconfig:
1> in the remainder of the procedures, consider each measId indicated in the IE of CondReconfigExecCondSN contained in the triggerConditionSN, as a measId in the VarMeasConfig associated with the SCG measConfig;
1> for each measId included in the measIdList within VarMeasConfig indicated in the CondReconfigExecCondSN contained in the triggerConditionSN associated to the condReconfigurationId:
2> if the entry condition(s) applicable for the event associated with that measId, is fulfilled for the applicable cells for all measurements after layer 3 filtering taken during the corresponding timeToTrigger defined for this event associated with that measId:
3> consider this event to be fulfilled;
2> if the measId for this event has been modified; or
2> if the leaving condition(s) applicable for this event associated with that measId, is fulfilled for the applicable cells for all measurements after layer 3 filtering taken during the corresponding timeToTrigger defined for this event associated with that measId:
3> consider this event associated to that measId to be not fulfilled;
1> if trigger conditions for all events associated with the measId(s) indicated in the IE of CondReconfigExecCondSN contained in the triggerConditionSN, are fulfilled:
2> consider the target cell candidate within the RRCReconfiguration message contained in nr-SecondaryCellGroupConfig in the RRCConnectionReconfiguration message, contained in the stored condReconfigurationToApply, associated to that condReconfigurationld, as a triggered cell;
2> initiate the conditional reconfiguration execution;

If multiple NR cells are triggered in conditional reconfiguration execution, it is up to UE implementation which one to select, e.g. the UE considers beams and beam quality to select one of the triggered cells for execution.

### Conditional Reconfiguration Execution

The UE shall:
1> if more than one triggered cell exists:
2> select one of the triggered cells as the selected cell for conditional reconfiguration execution;
1> else:
2> consider the triggered cell as the selected cell for conditional reconfiguration execution;
1> for the selected cell of conditional reconfiguration execution:
2> apply the stored condRRCReconfig of the selected cell and perform the actions;

If multiple NR cells are triggered in conditional reconfiguration execution, it is up to UE implementation which one to select, e.g. the UE considers beams and beam quality to select one of the triggered cells for execution.

### CondReconfigToAddModList

The IE CondReconfigToAddModList concerns a list of conditional reconfigurations to add or modify, with for each entry the condReconfigld and the associated condExecutionCond/condExecutionCondSCG and condRRCReconfig.

Technical features related to CondReconfigToAddModList information element are as follows.
condExecutionCond: The execution condition that needs to be fulfilled in order to trigger the execution of a conditional reconfiguration for CHO, CPA, intra-SN CPC without MN involvement or MN initiated inter-SN CPC. When configuring 2 triggering events (Meas Ids) for a candidate cell, network ensures that both refer to the same measObject. If network configures condEventD1 or condEventT1 for a candidate cell network configures a second triggering event condEventA3, condEventA4 or condEventA5. Network does not configure both condEventD1 or condEventT1 for the same candidate cell. For CPAC, the RRCReconfiguration message contained in condRRCReconfig cannot contain the field scg-State.
condExecutionCondSCG: Contains execution condition that needs to be fulfilled in order to trigger the execution of a conditional reconfiguration for SN initiated inter-SN CPC. The Meas Ids refer to the measConfig associated with the SCG. When configuring 2 triggering events (Meas Ids) for a candidate cell, network ensures that both refer to the same measObject. For each condReconfigurationId, the network always configures either triggerCondition or triggerConditionSCG (not both).
condRRCReconfig: The RRCReconfiguration message to be applied when the condition(s) are fulfilled. The RRCReconfiguration message contained in condRRCReconfig cannot contain the field conditionalReconfiguration, the field daps-Config or the configuration for target SCG for CHO.
condReconfigAdd: The field is mandatory present when a condReconfigId is being added. Otherwise the field is optional, need M.

### ReportConfigNR

The IE ReportConfigNR specifies criteria for triggering of an NR measurement reporting event or of a CHO, CPA or CPC event. For events labelled AN with N equal to 1, 2 and so on, measurement reporting events and CHO, CPA or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;
Event D1: Distance between UE and a reference location referenceLocation1 becomes larger than configured threshold1 Thresh and distance between UE and a reference location referenceLocation2 becomes shorter than configured threshold Thresh2;
CondEvent A3: Conditional reconfiguration candidate becomes amount of offset better than PCell/PSCell;
CondEvent A4: Conditional reconfiguration candidate becomes better than absolute threshold;
CondEvent A5: PCell/PSCell becomes worse than absolute threshold1 AND Conditional reconfiguration candidate becomes better than another absolute threshold2;
CondEvent D1: Distance between UE and a reference location referenceLocation1 becomes larger than configured threshold Thresh1 and distance between UE and a reference location referenceLocation2 of conditional reconfiguration candidate becomes shorter than configured threshold Thresh2;
CondEvent T1: Time measured at UE becomes more than configured threshold Thresh but is less than Thresh2;
Event X1: Seving L2 U2N Relay UE becomes worse than absolute threshold1 AND NR Cell becomes better than another absolute threshold2;
Event X2: Serving L2 U2N Relay UE becomes worse than absolute threshold;

For event I1, measurement reporting event is based on CLI measurement results, which can either be derived based on SRS-RSRP or CLI-RSSI.

Event I1: Interference becomes higher than absolute threshold.

Technical features related to ReportConfigNR information element are as below.

### Condtriggerconfig Field Descriptions

a3-Offset: Offset value(s) to be used in NR conditional reconfiguration triggering condition for cond event a3. The actual value is field value*0.5 dB.
a4-Threshold: Threshold value associated to the selected trigger quantity (e.g. RSRP, RSRQ, SINR) per RS Type (e.g. SS/PBCH block, CSI-RS) to be used in NR conditional reconfiguration triggering condition for cond event a4.
a5-Threshold1/a5-Threshold2: Threshold value associated to the selected trigger quantity (e.g. RSRP, RSRQ, SINR) per RS Type (e.g. SS/PBCH block, CSI-RS) to be used in NR conditional reconfiguration triggering condition for cond event a5. In the same condeventA5, the network configures the same quantity for the MeasTriggerQuantity of the a5-Threshold1 and for the MeasTriggerQuantity of the a5-Threshold2.
condEventId: Choice of NR conditional reconfiguration event triggered criteria.
duration: This field is used for defining the leaving condition T1-2 for conditional HO event condEventT1. Each step represents 100 ms.
t1-Threshold: The field counts the number of UTC seconds in 10 ms units since 00:00:00 on Gregorian calendar date 1 Jan. 1900 (midnight between Sunday, Dec. 31, 1899 and Monday, Jan. 1, 1900).
timeToTrigger: Time during which specific criteria for the event needs to be met in order to execute the conditional reconfiguration evaluation.

### Eventtriggerconfig Field Descriptions

a3-Offset/a6-Offset: Offset value(s) to be used in NR measurement report triggering condition for event a3/a6. The actual value is field value*0.5 dB.

aN-ThresholdM: Threshold value associated to the selected trigger quantity (e.g. RSRP, RSRQ, SINR) per RS Type (e.g. SS/PBCH block, CSI-RS) to be used in NR measurement report triggering condition for event number aN. If multiple thresholds are defined for event number aN, the thresholds are differentiated by M. The network configures aN-Threshold1 only for events A1, A2, A4, A5 and a5-Threshold2 only for event A5. In the same eventA5, the network configures the same quantity for the MeasTriggerQuantity of the a5-Threshold1 and for the MeasTriggerQuantity of the a5-Threshold2.

channelOccupancyThreshold: RSSI threshold which is used for channel occupancy evaluation.

distanceThresFromReference1, distanceThresFromReference2: Distance from a reference location configured with referenceLocation1 or referenceLocation2. Each step represents 50 m.

eventId: Choice of NR event triggered reporting criteria. If network configured eventD1 network shall configure includeCommonLocationInfo for the UE.

maxNrofRS-IndexesToReport: Max number of RS indexes to include in the measurement report for A1-A6 events.

maxReportCells: Max number of non-serving cells to include in the measurement report.

referenceLocation1, referenceLocation2: Reference locations used for location based event. The referenceLocation1 is associated to serving cell and referenceLocation2 is associated to candidate target cell. The value of the field is same as Ellipsoid-Point. The first/leftmost bit of the first octet contains the most significant bit.

reportAddNeighMeas: Indicates that the UE shall include the best neighbour cells per serving frequency.

reportAmount: Number of measurement reports applicable for eventTriggered as well as for periodical report types.

reportOnLeave: Indicates whether or not the UE shall initiate the measurement reporting procedure when the leaving condition is met for a cell in cellsTriggeredList.

reportQuantityCell: The cell measurement quantities to be included in the measurement report.

reportQuantityRS-Indexes: Indicates which measurement information per RS index the UE shall include in the measurement report.

timeToTrigger: Time during which specific criteria for the event needs to be met in order to trigger a measurement report.

use AllowedCellList: Indicates whether only the cells included in the allow-list of the associated measObject are applicable.

useT312: If value TRUE is configured, the UE shall use the timer T312 with the value t312 as specified in the corresponding measObjectNR. If value FALSE is configured, the timer

T312 is considered as disabled. Network configures value TRUE only if reportType is set to eventTriggered.

xN-ThresholdM: Threshold value associated to the selected trigger quantity (e.g. RSRP, RSRQ, SINR) per RS Type (e.g. SS/PBCH block, CSI-RS) to be used in NR measurement report triggering condition for event xN. If multiple thresholds are defined for event number xN, the thresholds are differentiated by M. x1-Threshold1 and x2-Threshold indicates the threshold value for the serving L2 U2N Relay UE, x1-Threshold2 indicates the threshold value for the NR Cells.

Meanwhile, the application of AI/ML to wireless communication has been studied to improve overall network and UE operation for performance and the ability to provide various services. Using AI/ML, both networks and UEs can predict mobility and share the results to improve performance.

Conditional mobility such as CHO, CPC and CPA were introduced for increasing mobility robustness and reducing latency for mobility execution. If network configures UE with one or more candidate target cell in configuration for conditional mobility, UE evaluates the condition of each configured candidate target cell. If execution condition for conditional mobility fulfils with one of the target cells, UE performs conditional mobility to the cell.

In 6G, the THz band may be used for the enormous amount of available bandwidth to meet the 6G requirement of Tbps data rates. However, in this high-frequency coverage, the cell coverage would be decreasing, and a lot of execution of conditional mobility would occur more frequently. It may cause a mobility too early, a mobility too late, or a mobility to the wrong cell. The failure of mobility results in low reliability and high latency, so that the data performance cannot meet the requirement for high data rate. In order to optimize the conditional mobility process in the high frequency environment, AI/ML can help to predict the suitable cell to execute conditional mobility.

Therefore, studies for conditional mobility based on measurement prediction in a wireless communication system are required.

Hereinafter, a method for conditional mobility based on measurement prediction in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

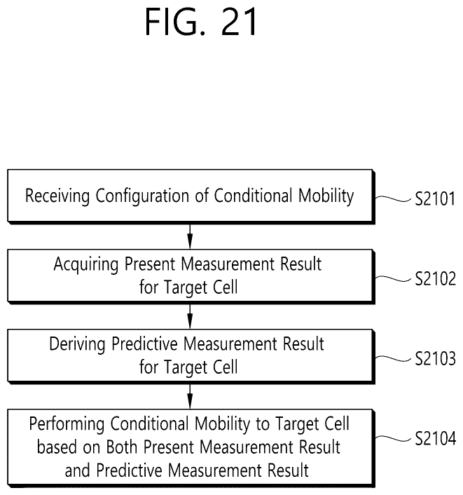

FIG. 21 shows an example of a method for conditional mobility based on measurement prediction in a wireless communication system, according to some embodiments of the present disclosure.

In particular, FIG. 21 shows an example of a method performed by a wireless device in a wireless communication system.

In step S2101, a wireless device may receive, from a network, a configuration of a conditional mobility for a target cell including at least one condition.

For example, the wireless device may receive, from the network, a measurement configuration including information on a measurement object.

For example, the information on the measurement object may include information on at least one cell. The information on the measurement object may include information on at least one reference signal and/or at least one Synchronization Signal Block (SSB). For example, the at least one reference signal may include a Channel State Information Reference Signal (CSI-RS).

In step S2102, a wireless device may acquire a present measurement result for the target cell at a first time point.

For example, the wireless device may perform measurements for the measurement object. The wireless device may acquire the present measurement result for the target cell based on the performed measurements.

In step S2103, a wireless device may derive a predictive measurement result for the target cell for a second time point.

For example, the wireless device may configure a machine learning model. The predictive measurement result for the target cell may be derived by using the machine learning model. For example, the wireless device may transmit, to the network, information on the machine learning model. For example, the wireless device may transmit, to the target cell, the information on the machine learning model after completing the conditional mobility.

For example, the wireless device may configure a prediction time window. The predictive measurement result may be derived based on the prediction time window.

For example, the prediction time window may start after a minimum time value from a current time point. That is, the wireless device may configure the prediction time after the minimum time value from the current time point.

For example, the prediction time window may end before a maximum time value from a current time point. That is, the wireless device may configure the prediction time before the maximum time value from the current time point.

In step S2104, a wireless device may perform the conditional mobility to the target cell based on both the present measurement result and the predictive measurement result satisfying the at least one condition.

For example, the wireless device may transmit, to the target cell, information on the present measurement result and the predictive measurement result after performing the conditional mobility.

For example, the wireless device may evaluate the at least one condition based on both the present measurement result and the predictive measurement result.

For example, the at least one condition may include a first condition for the present measurement result and/or a second condition for the predictive measurement result. When both the first condition and the second condition are satisfied, the wireless device may the conditional mobility to the target cell. In other words, the conditional mobility to the target cell may be performed based on both the first condition and the second condition being satisfied.

For example, even if the first condition for the present measurement result is satisfied, the wireless device may skip performing the conditional mobility to the target cell when the second condition for the predictive measurement result is not satisfied. In other words, the wireless device may skip performing the conditional mobility to the target cell based on that the first condition is satisfied but the condition is not satisfied.

For example, the first condition for the present measurement result and the second condition for the predictive measurement result may be the same condition. That is, the first condition and the second condition may be the same reporting condition (for example, a condEvent as below).

For another example, the first condition for the present measurement result and the second condition for the predictive measurement result may be the different from each other.

For example, the at least one condition, the first condition for the present measurement result, and/or the second condition for the predictive measurement result may include at least one of the follows:

(1) CondEvent A3: Neighbour becomes offset better than SpCell

The UE shall:
1> consider the entering condition for this event to be satisfied when condition A3-1, as specified below, is fulfilled;
1> consider the leaving condition for this event to be satisfied when condition A3-2, as specified below, is fulfilled;
1> use the SpCell for Mp, Ofp and Ocp.

The cell(s) that triggers the event has reference signals indicated in the measObjectNR associated to this event which may be different from the NR SpCell measObjectNR.

Inequality A3-1 (Entering condition)

$$Mn + Ofn + Ocn - Hys > Mp + Ofp + Ocp + Off$$

Inequality A3-2 (Leaving condition)

$$Mn + Ofn + Ocn + Hys < Mp + Ofp + Ocp + Off$$

The variables in the formula are defined as follows:

Mn is the measurement result of the neighbouring cell, not taking into account any offsets.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

Hys is the hysteresis parameter for this event (i.e. hysteresis as defined within reportConfigNR for this event).

Off is the offset parameter for this event (i.e. a3-Offset as defined within reportConfigNR for this event).

Mn, Mp are expressed in dBm in case of RSRP, or in dB in case of RSRQ and RS-SINR.

Ofn, Ocn, Ofp, Ocp, Hys, Off are expressed in dB.

(2) CondEvent A4: Neighbour becomes better than threshold

The UE shall:
1> consider the entering condition for this event to be satisfied when condition A4-1, as specified below, is fulfilled;
1> consider the leaving condition for this event to be satisfied when condition A4-2, as specified below, is fulfilled.

Inequality A4-1 (Entering condition)

$$Mn + Ofn + Ocn - Hys > Thresh$$

Inequality A4-2 (Leaving condition)

$$Mn + Ofn + Ocn + Hys < Thresh$$

The variables in the formula are defined as follows:

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Thresh is the threshold parameter for this event (i.e. a4-Threshold as defined within reportConfigNR for this event).

Mn is expressed in dBm in case of RSRP, or in dB in case of RSRQ and RS-SINR.

Ofn, Ocn, Hys are expressed in dB.

Thresh is expressed in the same unit as Mn.

(3) CondEvent A5: SpCell becomes worse than threshold1 and neighbour becomes better than threshold2

The UE shall:
1> consider the entering condition for this event to be satisfied when both condition A5-1 and condition A5-2, as specified below, are fulfilled;
1> consider the leaving condition for this event to be satisfied when condition A5-3 or condition A5-4, i.e. at least one of the two, as specified below, is fulfilled;
1> use the SpCell for Mp.

The parameters of the reference signal(s) of the cell(s) that triggers the event are indicated in the measObjectNR associated to the event which may be different from the measObjectNR of the NR SpCell.

Inequality A5-1 (Entering condition 1)

$$Mp + Hys < Thresh 1$$

Inequality A5-2 (Entering condition 2)

$$Mn + Ofn + Ocn - Hys > Thresh 2$$

Inequality A5-3 (Leaving condition 1)

$$Mp - Hys > Thresh 1$$

Inequality A5-4 (Leaving condition 2)

$$Mn + Ofn + Ocn + Hys < Thresh 2$$

The variables in the formula are defined as follows:

Mp is the measurement result of the NR SpCell, not taking into account any offsets.

Ocn is the cell specific offset of the neighbour cell (i.e. cellIndividualOffset as defined within measObjectNR corresponding to the neighbour cell), and set to zero if not configured for the neighbour cell.

Thresh1 is the threshold parameter for this event (i.e. a5-Threshold1 as defined within reportConfigNR for this event).

Thresh2 is the threshold parameter for this event (i.e. a5-Threshold2 as defined within reportConfigNR for this event).

Thresh1is expressed in the same unit as Mp.

Thresh2 is expressed in the same unit as Mn.

(4) CondEvent D1:

The UE shall:
1> consider the entering condition for this event to be satisfied when both condition D1-1 and conditionD1-2, as specified below, is fulfilled;
1> consider the leaving condition for this event to be satisfied when condition

D1-3 or conditionD1-4, as specified below, is fulfilled;

Inequality D1-1 (Entering condition 1)

$$Ml 1 - Hys > Thresh 1$$

Inequality D1-2 (Entering condition 2)

$$Ml 2 + Hys < Thresh 2$$

Inequality D1-3 (Leaving condition 1)

$$Ml 1 + Hys < Thresh 1$$

Inequality D1-4 (Leaving condition 2)

$$Ml 2 - Hys > Thresh 2$$

The variables in the formula are defined as follows:

Ml1 is the UE location, represented by the distance between UE and a reference location parameter for this event (i.e. referenceLocation1 as defined within reportConfigNR for this event), not taking into account any offsets.

Ml2 is the UE location, represented by the distance between UE and a reference location parameter for this event (i.e. referenceLocation2 as defined within reportConfigNR for this event), not taking into account any offsets but.

Thresh1 is the threshold for this event defined as a distance, configured with parameter distanceFromReference1, from a reference location configured with parameter referenceLocation within reportConfigNR for this event.

Thresh2 is the threshold for this event defined as a distance, configured with parameter distanceFromReference2, from a reference location configured with parameter referenceLocation2 within reportConfigNR for this event.

Ml1 is expressed in meters.

Ml2 is expressed in meters.

Hys is expressed in the same unit as Ml1.

Thresh is expressed in the same unit as Ml1.

(5) CondEvent T1

The UE shall:
1> consider the entering condition for this event to be satisfied when condition T1-1, as specified below, is fulfilled;
1> consider the leaving condition for this event to be satisfied when condition T1-2, as specified below, is fulfilled;

Inequality T1-1 (Entering condition)

$$Mt > Thresh 1$$

Inequality T1-2 (Leaving condition)

$$Mt > Thresh 1 + Duration$$

The variables in the formula are defined as follows:

Mt is the time measured at UE.

Thresh1 is the threshold parameter for this event (i.e. t1-Threshold as defined within reportConfigNR for this event).

Duration is the duration parameter for this event (i.e. duration as defined within reportConfigNR for this event).

Mt is expressed in ms.

Thresh is expressed in the same unit as Mt.

According to some embodiments of the present disclosure, the wireless device may be in communication with at least one of a user equipment, a network, or an autonomous vehicle other than the wireless device.

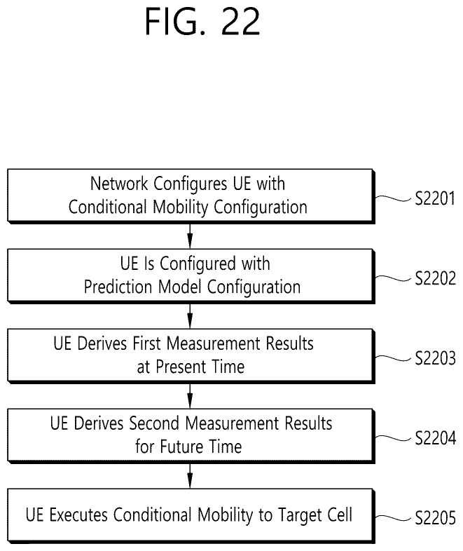

FIG. 22 shows an example of a method for conditional mobility based on measurement prediction in a wireless communication system, according to some embodiments of the present disclosure.

In FIG. 22, a method for implementing conditional mobility to an appropriate cell based on a predictive measurement result as well as a current measurement result is provided. The UE may execute conditional mobility for a cell when the current measurement result for the current time t and the predicted measurement result for the future time t+t′ satisfy execution conditions. If the UE performs conditional mobility to the cell with guaranteed cell quality until the future, it is possible to increase mobility robustness and reduce latency for mobility execution in high frequency coverage.

In step S2201, the network may configure UE with conditional mobility configuration for execution of conditional mobility.
> The conditional mobility configuration may include conditional reconfiguration(s) for candidate target cell(s), and execution condition(s).
> The conditional mobility configuration may include one or more execution conditions for a conditional reconfiguration.
>> A first execution condition may be for a non-predictive measurement.
>> A second execution condition may be for a predictive measurement.
>>> UE may consider the second execution condition is same as the first execution condition if the second execution condition is not configured.
> The conditional mobility configuration may include prediction time information.
>> The prediction time information may include a prediction time value, T1.
>> The prediction time information may include a prediction time window-related parameter T2.
>>> The prediction time parameter indicates the start time of prediction window (T2_min in the example below)
>>> The prediction time parameter indicates the end time of prediction window (T2_max in the example below)>
> For example, conditional mobility configuration may comprise the following:
>> CondRRCReconfig #1
>>> Conditional reconfiguration parameters in TS 38.331 v17.0.0
>> CondRRCReconfig #2
>>> Conditional reconfiguration parameters in TS 38.331 v17.0.0
>> CondExecutionCond #1
>>> Conditional execution condition parameters in TS 38.331 v17.0.0
>> CondExecutionCond #2
>>> Conditional execution condition parameters in TS 38.331 v17.0.0
>>> Prediction time information related to Prediction time value T1
>> CondExecutionCond #3
>>> Conditional execution condition parameters in TS 38.331 v17.0.0
>>> Prediction time information related to Prediction time window T2
>> CondReconfigId #1
>>> CondRRCReconfig #1
>>> CondExecutionCond #1
>> CondReconfigId #2
>>> CondRRCReconfig #1
>>> CondExecutionCond #1
>>> CondExecutionCond #1
>> CondReconfigId #3
>>> CondRRCReconfig #2
>>> CondExecutionCond #2
>>> CondExecutionCond #2
>> CondReconfigId #4
>>> CondRRCReconfig #2
>>> CondExecutionCond #3
>>> CondExecutionCond #3
>> CondReconfigId #5
>>> CondRRCReconfig #2
>>> CondExecutionCond #1
>>> CondExecutionCond #2
>> In this example,
>>> Based on the conditional reconfiguration ID #1, the conditional reconfiguration #1 is associated with the predictive measurement, but prediction time information is not associated with respect to conditional execution condition #1. The execution condition #1 is applied to the current measurement results for the current time (=t) and the predictive measurement results for a certain prediction time.
>>> Based on the conditional reconfiguration ID #2, the conditional reconfiguration #1 is associated with the predictive measurement, but prediction time information is not associated with respect to conditional execution condition #1. The execution condition #1 is applied to the current measurement results for the current time (=t) and the predictive measurement results for a certain prediction time.
>>> Based on the conditional reconfiguration ID #3, the conditional reconfiguration #1 is associated with prediction time value T1 with respect to conditional execution condition #2. The execution condition #2 is applied to the current measurement results for the current time (=t) and the predictive measurement results for the prediction time (=t+T1).
>>> Based on the conditional reconfiguration ID #4, the conditional reconfiguration #4 is associated with predication time window T2 with respect to conditional execution condition #3. The execution condition #3 is applied to the current measurement results for the current time (=t) and the predictive measurement results for the prediction time window T2 as following:
>>>> If T2 is related to the start time of prediction window (T2_min), UE evaluates the execution condition for the time [t+T2, . . . ], i.e., evaluation is done for the time that is after (or not prior to) the time t+T2.
>>>> If T2 is related to the end time of the prediction window (T2_max), UE evaluates the execution condition within between t and t+T2.
>>> Based on the conditional reconfiguration ID #5, the conditional reconfiguration #1 is associated with prediction time value T1 with respect to conditional execution condition #2. The execution condition #1 is applied to the current measurement results for the current time (=t), and the execution condition #2 is applied to the predictive measurement results for the prediction time (=t+T1).

In step S2202, for performing predictive measurements, the UE may be configured with a more prediction model configuration.
> The prediction model configuration may include prediction model structure information,
>> The network may configure a machine learning model to be used by the UE.
>>> The network may include a machine learning type, such as reinforcement learning, supervised learning, or unsupervised learning.
>>> The network may include a machine learning model, such as DNN, CNN, RNN, and DRL.
>>> The configured ML model may be a pre-trained ML model that has been already trained by network a-priori
>>>> The configured ML model is described by a model description information including model structure and parameters.
>>>> For example, neural-network based model may comprise input layer, output layer, and hidden layer(s), where each layer comprises one or more neurons (equivalently nodes).
>>>>> Different layers are connected based on the connections between neurons of different layers
>>>>>> Each connection of two different neurons in two different layers may be directive (e.g. neuron A to neuron B, meaning that the output of neuron A is fed into the neuron B)
>>>> Each neuron may provide input to one or several connected neurons (1 to N connection).
>>>>>> For a connection between two neurons (neuron A to neuron B), output of one neuron (A) is scaled by a weight, and the other neuron takes the scaled output as its input.
>>>>>>>> Each neuron may take input from one or several connected neurons (N to 1 connection), and combines the input from the connected neurons, and produces an output based on activation function.
>>> The configured ML model may be a ML model to be trained.
>>>> The configured ML model is described by a model description information including model structure and initial parameters that are to be trained.
>>> When network configures the ML model to be trained, it may also configure training parameters such as optimization objective(s) and optimization-related configuration parameters.
>>> The network may include machine learning input parameters for the machine learning model, such as UE location information, radio measurements related to serving cell and neighbouring cells, UE mobility history.
>>> The network may include machine learning output, such as UE trajectory prediction, predicted target cell, predicted time for handover, and UE traffic prediction.
>> The UE may perform a machine learning model training, validation, and testing which may generate model performance metrics based on the prediction model configuration.
>>> The UE may perform a model training with the machine learning input parameters.
>> UE may use the configured ML model to perform ML task such as predictions of measurements.
>>> The UE may derive machine learning output(s).
>>> The UE may infer from the outputs and use the outputs as feedback for the machine learning model.
>> The UE may send feedback to the network about the results related to machine learning outputs and the accuracy of the machine learning model.
>>> The network may update the machine learning model and parameters related to the machine learning model.

In step S2203, the UE may derive first measurement results at time to based on the conditional mobility configuration.
> The first measurement is a non-predictive measurement.

In step S2204, the UE may derive second measurement results for a future time based on the conditional mobility configuration and configured ML model.
> The second measurement is a predictive measurement.
> The UE may perform measurements and perform a necessary operation to derive measurement results.
> The UE may derive predictive measurement results on the concerned conditional reconfiguration based on prediction time information associated with the second execution condition.
>> For example, at the current time to, if prediction time value T1 is configured, the UE may derive the predictive measurement result for the time t0+T1.
>> For example, at the current time to, if T2 related to the start time of prediction window (T2_min) is configured, the UE may derive the predictive measurement result for the time period [t0+T2, o].
>> For example, at the current time to, if T2 related to the end time of prediction window (T2_max) is configured, the UE may derive the predictive measurement result for the time period [t0, t0+T2].
>> For example, at the current time to, if the particular prediction time is absent, the UE may derive the predictive measurement result for the time period [t0, o].
>> To derive predictive measurement results, the UE may apply the configured prediction model.

In step S2205, the UE executes conditional mobility to the target cell associated with corresponding conditional reconfiguration when the first measurement results satisfy the first execution condition and the second measurement results satisfy the second execution condition, for conditional mobility.
> The UE executes conditional mobility to the target cell if the first and second measurement results satisfy the applicable execution condition.
> The UE does not execute conditional mobility to the target cell if either the first measurement results or the second measurement results does not satisfy the execution condition.
> The UE may send a complete message for conditional mobility including at least one of the following
>> The conditional reconfiguration ID
>> The current time at which measurement results satisfy the execution condition, denoted by t0
>> The prediction time value (T1 in the example)
>> The prediction window related parameter (T2 in the example below)
>> The current measurement result at current time t0, denoted by M (t0)
>> The time at which the predictive measurement result is derived, denoted by t1
>> The predictive measurement results of time at which the predictive measurement result is derived, dented by P^{t1} (t₀)
>> Multiple predictive measurement results within the prediction window.
>>> A series of {time, predictive measurement results of the time} can be included for each time within the prediction window. The time interval of the entries can be configured by network.
>>> For example, for the time duration [t_a, t_a+T], UE provides predictive measurement results for multiple times, t_a+x_1, t_a+x_2, . . . , t_a+x_k, . . . ,t_a+x_n with x_k ≥0 and x_k≤T for k=1, . . . , n.

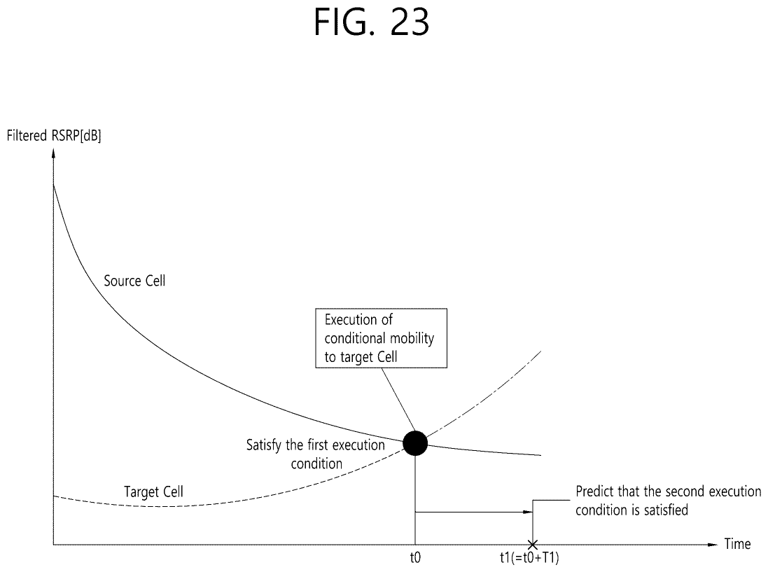

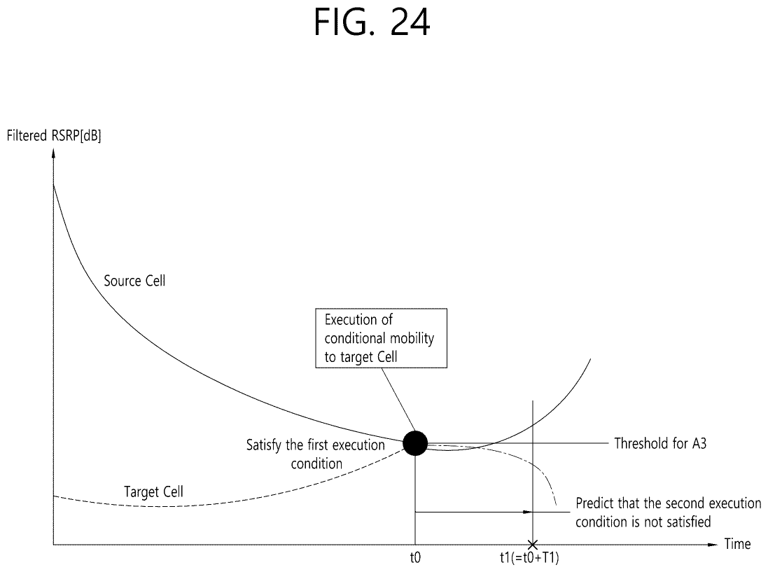

FIGS. 23 and 24 show examples of execution of conditional mobility based on current measurement result and predictive measurement result for a particular time.

FIG. 23 illustrates an example of a predictive measurement report for A3 event for the current time and the particular time t1. FIG. 24 illustrates another example of a predictive measurement report for A3 event for the current time and the particular time t1.
1) The network configures conditional mobility configurations of a cell, including conditional reconfiguration(s) for candidate of target cell(s) and execution condition(s), and a predictive conditional mobility configuration with predictive time value T1.
> The conditional mobility configuration includes two execution conditions for a conditional reconfiguration.
>> A first execution condition is for a non-predictive measurement.
>> A second execution condition is for a predictive measurement.
>> The T1 is associated with the second execution condition.
2) The UE derive a first measurement result at current time to based on the conditional reconfiguration.
> The first measurement results are non-predictive measurement results.
3) The UE derive a second measurement result for the future time t1 (=t0+T1) according to the predictive time information associated with the second execution condition.
> The second measurement results are predictive measurement results.
4-1) The UE executes conditional mobility to the target cell associated with conditional reconfiguration if the first measurement result satisfies the first execution condition and the second measurement result satisfies the second execution condition. (FIG. 23)
4-2) The UE does not execute conditional mobility to the target cell associated with conditional reconfiguration if the second measurement result does not satisfy the second execution condition even if the first measurement result satisfies the first execution condition. (FIG. 24)
> The UE may stop predictive measurement if the predictive measurement result does not satisfy the execution condition.

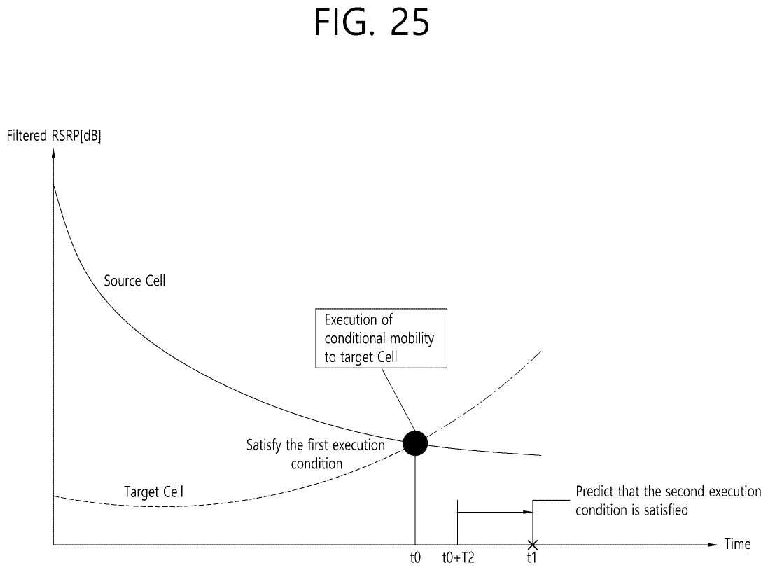

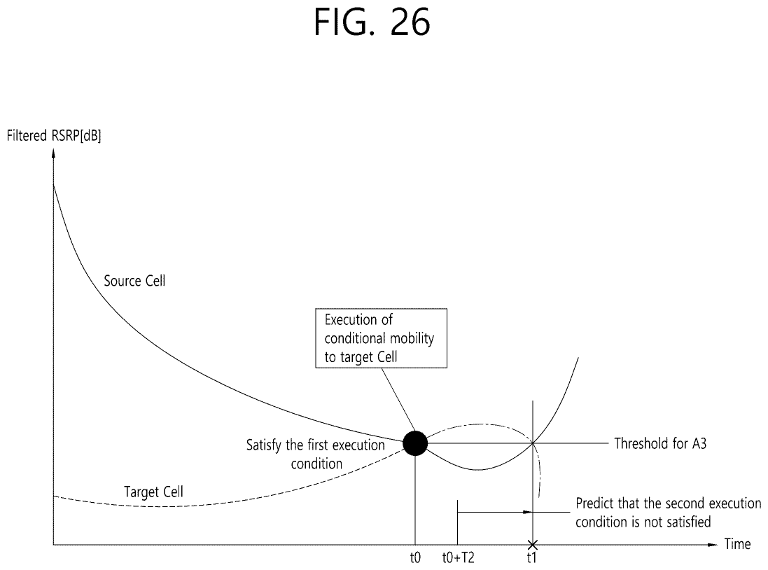

FIGS. 25 and 26 show examples of execution of conditional mobility based on current measurement result and predictive measurement result for a certain time with prediction time window for a minimal value.

FIG. 25 illustrates an example of a predictive measurement report for A3 event for the current time and the certain time t1. FIG. 26 illustrates another example of a predictive measurement report for A3 event for the current time and the certain time t1.
1) The network configures conditional mobility configurations of a cell, including conditional reconfiguration(s) and execution condition(s), and a predictive conditional mobility configuration with predictive time window T2 (or T2_min).
> The conditional mobility configuration includes two execution conditions for a conditional reconfiguration.
>> A first execution condition may be for a non-predictive measurement.
>> A second execution condition may be for a predictive measurement.
> The T2 is associated with the second execution condition and is a minimal time value for predictive measurements.
2) The UE derive a first measurement result at current time t0 based on the conditional reconfiguration.
> The first measurement results are non-predictive measurement results.
3) The UE derive a second measurement result for a certain future time t1 that is not prior to the time t0+T2 according to the predictive time information associated with the second execution condition.
> The second measurement results are predictive measurement results.
4-1) The UE executes conditional mobility to the target cell associated with conditional reconfiguration if the first measurement result satisfies the first execution condition and the second measurement result satisfies the second execution condition. (FIG. 25)
4-2) The UE does not execute conditional mobility to the target cell associated with conditional reconfiguration if the second measurement result does not satisfy the second execution condition even if the first measurement result satisfies the first execution condition. (FIG. 26)
> The UE may stop predictive measurement if the predictive measurement result does not satisfy the execution condition.

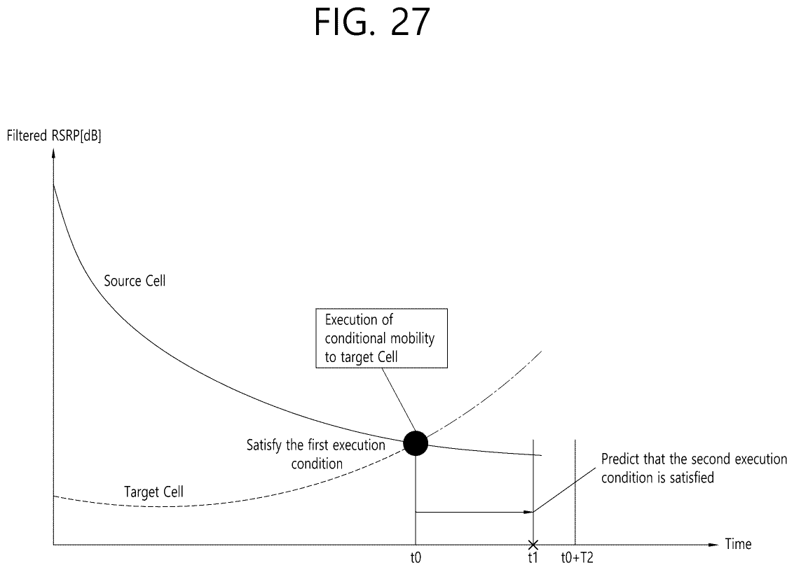

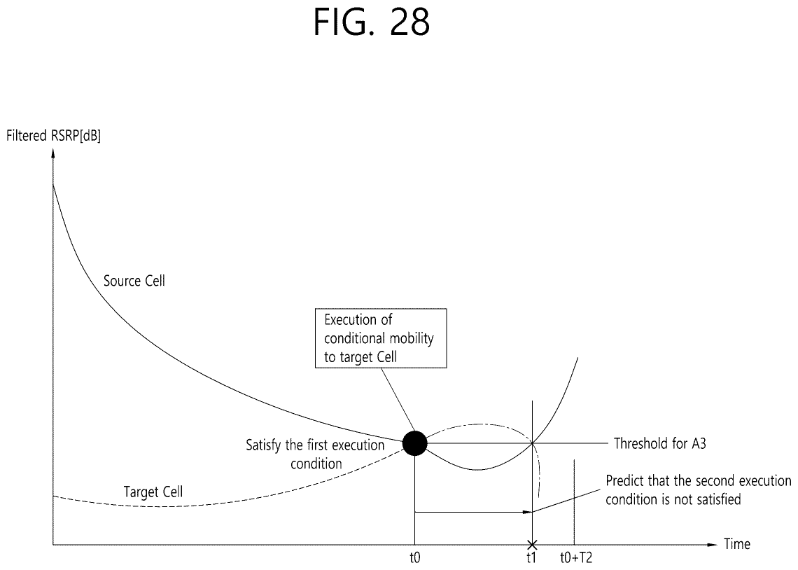

FIGS. 27 and 28 show examples of execution of conditional mobility based on current measurement result and predictive measurement result for a certain time with prediction time window for a maximum value.

FIG. 27 illustrates an example of a predictive measurement report for A3 event for the current time and the certain time t1. FIG. 28 illustrates another example of a predictive measurement report for A3 event for the current time and the certain time t1.
1) The network configures conditional mobility configurations of a cell, including conditional reconfiguration(s) and execution condition(s), and a predictive conditional mobility configuration with predictive time window T2 (or T2_max).
> The conditional mobility configuration includes two execution conditions for a conditional reconfiguration.
>> A first execution condition may be for a non-predictive measurement.
>> A second execution condition may be for a predictive measurement.
> The T2 is associated with the second execution condition and is a maximum time value for predictive measurements.
2) The UE derive a first measurement result at current time t0 based on the conditional reconfiguration.
> The first measurement results are non-predictive measurement results.
3) The UE derive a second measurement result for a certain future time t1 that is prior to t0+T2 according to the predictive time information associated with the second execution condition.
> The second measurement results are predictive measurement results.
4-1) The UE executes conditional mobility to the target cell associated with conditional reconfiguration if the first measurement result satisfies the first execution condition and the second measurement result satisfies the second execution condition. (FIG. 27)
4-2) The UE does not execute conditional mobility to the target cell associated with conditional reconfiguration if the second measurement result does not satisfy the second execution condition even if the first measurement result satisfies the first execution condition. (FIG. 28)
> The UE may stop predictive measurement if the predictive measurement result does not satisfy the execution condition before the maximum time t0+T2.

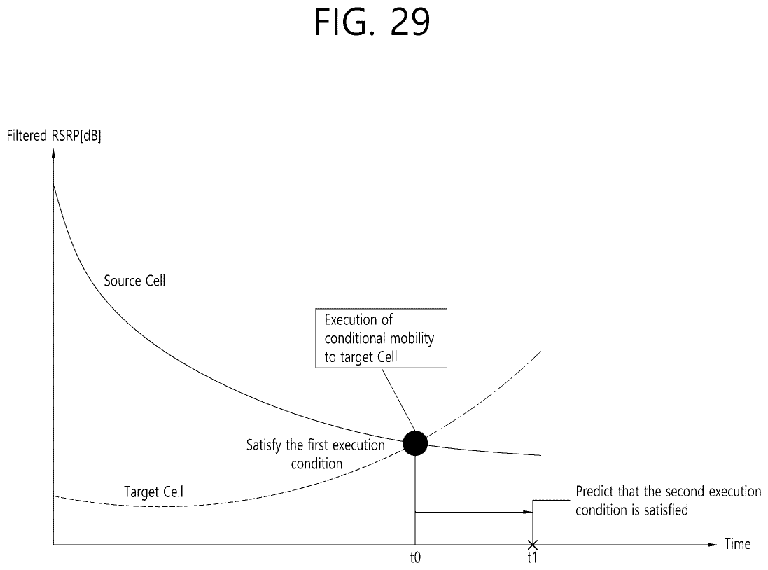

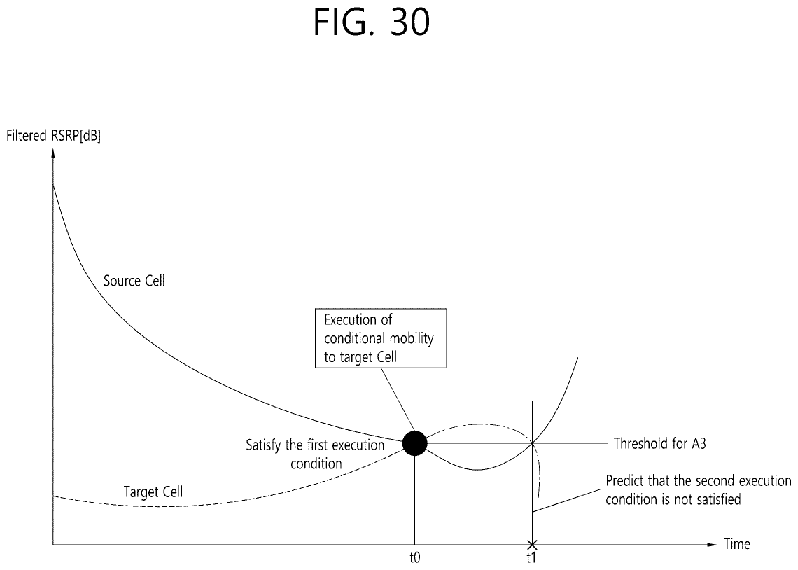

FIGS. 29 and 30 show examples of execution of conditional mobility based on current measurement result and predictive measurement result for a certain time.

FIG. 29 illustrates an example of a predictive measurement report for A3 event for the current time and the certain time t1. FIG. 30 illustrates another example of a predictive measurement report for A3 event for the current time and the certain time t1.
1) The network configures conditional mobility configurations of a cell, including conditional reconfiguration(s) and execution condition(s), and a predictive conditional mobility configuration.
> The conditional mobility configuration includes two execution conditions for a conditional reconfiguration.
>> A first execution condition may be for a non-predictive measurement.
>> A second execution condition may be for a predictive measurement.
2) The UE derive a first measurement result at current time t0 based on the conditional reconfiguration.
> The first measurement results are non-predictive measurement results.
3) The UE derive a second measurement result for a certain future time t1.
> The second measurement results are predictive measurement results.
4-1) The UE executes conditional mobility to the target cell associated with conditional reconfiguration if the first measurement result satisfies the first execution condition and the second measurement result satisfies the second execution condition. (FIG. 29)
4-2) The UE does not execute conditional mobility to the target cell associated with conditional reconfiguration if the second measurement result does not satisfy the second execution condition even if the first measurement result satisfies the first execution condition. (FIG. 30)
> The UE may stop predictive measurement if the predictive measurement result does not satisfy the execution condition.

According to some embodiments of the present disclosure, a wireless device may receive a conditional mobility configuration for a cell from a network. The configuration may comprise a first execution condition and a second execution condition. The second execution condition may be applicable for the predictive measurements.

The wireless device may perform measurement of the cell and derive a first measurement result at time t. Time t may be the current time.

The wireless device may derive a second measurement result at time t, for a future time t+T.

The wireless device may perform a conditional mobility to the cell at time t if the first measurement result satisfies the first execution condition and the second measurement result satisfies the second execution condition.

Some of the detailed steps shown in the examples of FIGS. 21-30 may not be essential steps and may be omitted. In addition to the steps shown in FIGS. 21-30, other steps may be added, and the order of the steps may vary. Some of the above steps may have their own technical meaning.

Hereinafter, an apparatus for conditional mobility based on measurement prediction in a wireless communication system, according to some embodiments of the present disclosure, will be described. Herein, the apparatus may be a wireless device (100 or 200) in FIGS. 2, 3, and 5.

For example, a wireless device may perform the methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be adapted to control the transceiver 106 to receive, from a network, a configuration of a conditional mobility for a target cell including at least one condition. The processor 102 may be adapted to acquire a present measurement result for the target cell at a first time point. The processor 102 may be adapted to derive a predictive measurement result for the target cell for a second time point. The processor 102 may be adapted to perform the conditional mobility to the target cell based on both the present measurement result and the predictive measurement result satisfying the at least one condition.

For example, the processor 102 may be adapted to evaluate the at least one condition based on both the present measurement result and the predictive measurement result.

For example, the at least one condition may include a first condition for the present measurement result and/or a second condition for the predictive measurement result.

For example, the conditional mobility to the target cell may be performed based on both the first condition and the second condition being satisfied.

For example, the processor 102 may be adapted to skip performing the conditional mobility to the target cell based on that the first condition is satisfied but the second condition is not satisfied.

For example, the processor 102 may be adapted to control the transceiver 106 to receive, from the network, a measurement configuration including information on a measurement object.

For example, the information on the measurement object may include information on at least one cell.

For example, the information on the measurement object may include information on at least one reference signal and/or at least one Synchronization Signal Block (SSB).

For example, the processor 102 may be adapted to configure a machine learning model. The predictive measurement result for the target cell may be derived by using the machine learning model.

For example, the processor 102 may be adapted to control the transceiver 106 to transmit, to the network, information on the machine learning model.

For example, the processor 102 may be adapted to control the transceiver 106 to transmit, to the target cell, information on the present measurement result and the predictive measurement result after performing the conditional mobility.

For example, the processor 102 may be adapted to configure a prediction time window.

For example, the prediction time window may start after a minimum time value from a current time point. The predictive measurement result may be derived based on the prediction time window.

For example, the processor 102 may be adapted to configure a prediction time window. For example, the prediction time window ends before a maximum time value from a current time point. The predictive measurement result may be derived based on the prediction time window.

For example, the processor 102 may be configured to control the transceiver 106 to be in communication with at least one of a user equipment, a network, or an autonomous vehicle other than the wireless device.

Hereinafter, a processor for a wireless device for conditional mobility based on measurement prediction in a wireless communication system, according to some embodiments of the present disclosure, will be described.

The processor may be adapted to control the wireless device to receive, from a network, a configuration of a conditional mobility for a target cell including at least one condition. The processor may be adapted to control the wireless device to acquire a present measurement result for the target cell at a first time point. The processor may be adapted to control the wireless device to derive a predictive measurement result for the target cell for a second time point. The processor may be adapted to control the wireless device to perform the conditional mobility to the target cell based on both the present measurement result and the predictive measurement result satisfying the at least one condition.

For example, the processor may be adapted to control the wireless device to evaluate the at least one condition based on both the present measurement result and the predictive measurement result.

For example, the at least one condition may include a first condition for the present measurement result and/or a second condition for the predictive measurement result.

For example, the conditional mobility to the target cell may be performed based on both the first condition and the second condition being satisfied.

For example, the processor may be adapted to control the wireless device to skip performing the conditional mobility to the target cell based on that the first condition is satisfied but the second condition is not satisfied.

For example, the processor may be adapted to control the wireless device to receive, from the network, a measurement configuration including information on a measurement object.

For example, the information on the measurement object may include information on at least one cell.

For example, the information on the measurement object may include information on at least one reference signal and/or at least one Synchronization Signal Block (SSB).

For example, the processor may be adapted to control the wireless device to configure a machine learning model. The predictive measurement result for the target cell may be derived by using the machine learning model.

For example, the processor may be adapted to control the wireless device to transmit, to the network, information on the machine learning model.

For example, the processor may be adapted to control the wireless device to transmit, to the target cell, information on the present measurement result and the predictive measurement result after performing the conditional mobility.

For example, the processor may be adapted to control the wireless device to configure a prediction time window. For example, the prediction time window may start after a minimum time value from a current time point. The predictive measurement result may be derived based on the prediction time window.

For example, the processor may be adapted to control the wireless device to configure a prediction time window. For example, the prediction time window ends before a maximum time value from a current time point. The predictive measurement result may be derived based on the prediction time window.

For example, the processor may be adapted to control the wireless device to be in communication with at least one of a user equipment, a network, or an autonomous vehicle other than the wireless device.

Hereinafter, a non-transitory computer-readable medium has stored thereon a plurality of instructions for conditional mobility based on measurement prediction in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive, from a network, a configuration of a conditional mobility for a target cell including at least one condition. The stored a plurality of instructions may cause the wireless device to acquire a present measurement result for the target cell at a first time point. The stored a plurality of instructions may cause the wireless device to derive a predictive measurement result for the target cell for a second time point. The stored a plurality of instructions may cause the wireless device to perform the conditional mobility to the target cell based on both the present measurement result and the predictive measurement result satisfying the at least one condition.

For example, the stored a plurality of instructions may cause the wireless device to evaluate the at least one condition based on both the present measurement result and the predictive measurement result.

For example, the at least one condition may include a first condition for the present measurement result and/or a second condition for the predictive measurement result.

For example, the conditional mobility to the target cell may be performed based on both the first condition and the second condition being satisfied.

For example, the stored a plurality of instructions may cause the wireless device to skip performing the conditional mobility to the target cell based on that the first condition is satisfied but the second condition is not satisfied.

For example, the stored a plurality of instructions may cause the wireless device to receive, from the network, a measurement configuration including information on a measurement object.

For example, the information on the measurement object may include information on at least one cell.

For example, the information on the measurement object may include information on at least one reference signal and/or at least one Synchronization Signal Block (SSB).

For example, the stored a plurality of instructions may cause the wireless device to configure a machine learning model. The predictive measurement result for the target cell may be derived by using the machine learning model.

For example, the stored a plurality of instructions may cause the wireless device to transmit, to the network, information on the machine learning model.

For example, the stored a plurality of instructions may cause the wireless device to transmit, to the target cell, information on the present measurement result and the predictive measurement result after performing the conditional mobility.

For example, the stored a plurality of instructions may cause the wireless device to configure a prediction time window. For example, the prediction time window may start after a minimum time value from a current time point. The predictive measurement result may be derived based on the prediction time window.

For example, the stored a plurality of instructions may cause the wireless device to configure a prediction time window. For example, the prediction time window ends before a maximum time value from a current time point. The predictive measurement result may be derived based on the prediction time window.

According to some embodiments of the present disclosure, the stored a plurality of instructions may cause the wireless device to be in communication with at least one of a user equipment, a network, or an autonomous vehicle other than the wireless device.

Hereinafter, a method performed by a base station (BS) for conditional mobility based on measurement prediction in a wireless communication system, according to some embodiments of the present disclosure, will be described.

The BS may transmit, to a wireless device, a configuration of a conditional mobility for a target cell including at least one condition. The conditional mobility to the target cell may be performed based on both a present measurement result for the target cell and a predictive measurement result for the target cell satisfying the at least one condition. The present measurement result for the target cell may be acquired by the wireless device at a first time point. The predictive measurement result for the target cell may be derived by the wireless device for a second time point.

Hereinafter, a base station (BS) for conditional mobility based on measurement prediction in a wireless communication system, according to some embodiments of the present disclosure, will be described.

The BS may include a transceiver, a memory, and a processor operatively coupled to the transceiver and the memory.

The processor may be configured to control the transceiver to transmit, to a wireless device, a configuration of a conditional mobility for a target cell including at least one condition. The conditional mobility to the target cell may be performed based on both a present measurement result for the target cell and a predictive measurement result for the target cell satisfying the at least one condition. The present measurement result for the target cell may be acquired by the wireless device at a first time point. The predictive measurement result for the target cell may be derived by the wireless device for a second time point.

The present disclosure can have various advantageous effects.

According to some embodiments of the present disclosure, a wireless device could efficiently handle execution of conditional mobility based on current measurement result and predictive measurement result.

For example, if the UE performs conditional mobility to the cell with guaranteed cell quality until the future, it is possible to increase mobility robustness and reduce latency for mobility execution in high frequency coverage.

In other words, by enabling the UE to perform conditional mobility to a cell with guaranteed cell quality in the future, it becomes feasible to enhance mobility robustness and reduce latency for mobility execution in high-frequency coverage.

For example, by performing CHO based on predictive measurement results, it is possible to improve the efficiency of handover.

For example, by utilizing both predictive measurement results and actual measurement results, it becomes possible to receive stable services from the target cell.

According to some embodiments of the present disclosure, a wireless network system could provide an efficient solution for conditional mobility considering measurement prediction.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method, comprising:
receiving, by a wireless device from a network, a configuration of a conditional mobility for a target cell including at least one condition;
acquiring, by the wireless device, a present measurement result for the target cell at a first time point;
deriving, by the wireless device, a predictive measurement result for the target cell for a second time point; and
performing, by the wireless device, the conditional mobility to the target cell based on both the present measurement result and the predictive measurement result satisfying the at least one condition.

2. The method of claim 1, wherein the method comprises,
evaluating, by the wireless device, the at least one condition based on both the present measurement result and the predictive measurement result.

3. The method of claim 1,
wherein the at least one condition includes a first condition for the present measurement result and/or a second condition for the predictive measurement result.

4. The method of claim 3,
wherein the conditional mobility to the target cell is performed based on both the first condition and the second condition being satisfied.

5. The method of claim 3, wherein the method further comprises,
skipping, by the wireless device, performing the conditional mobility to the target cell based on that the first condition is satisfied but the second condition is not satisfied.

6. The method of claim 1, wherein the method comprises,
receiving, by the wireless device from the network, a measurement configuration including information on a measurement object.

7. The method of claim 6,
wherein the information on the measurement object includes information on at least one cell.

8. The method of claim 6,
wherein the information on the measurement object includes information on at least one reference signal and/or at least one Synchronization Signal Block (SSB).

9. The method of claim 1, wherein the method further comprises,
configuring, by the wireless device, a machine learning model,
wherein the predictive measurement result for the target cell is derived by using the machine learning model.

10. The method of claim 9, wherein the method further comprises,
transmitting, by the wireless device to the network, information on the machine learning model.

11. The method of claim 1, wherein the method further comprises,
transmitting, by the wireless device to the target cell, information on the present measurement result and the predictive measurement result after performing the conditional mobility.

12. The method of claim 1, wherein the method further comprises,
configuring, by the wireless device, a prediction time window,
wherein the prediction time window starts after a minimum time value from a current time point, and
wherein the predictive measurement result is derived based on the prediction time window.

13. The method of claim 1, wherein the method further comprises,
configuring, by the wireless device, a prediction time window,
wherein the prediction time window ends before a maximum time value from a current time point, and
wherein the predictive measurement result is derived based on the prediction time window.

14. The method of claim 1,
wherein the wireless device is in communication with at least one of a user equipment, a network, or an autonomous vehicle other than the wireless device.

15. A wireless device, comprising:
a transceiver;
a memory; and
at least one processor operatively coupled to the transceiver and the memory, and adapted to:
control the transceiver to receive, from a network, a configuration of a conditional mobility for a target cell including at least one condition;
acquire a present measurement result for the target cell at a first time point;
derive a predictive measurement result for the target cell for a second time point; and
perform the conditional mobility to the target cell based on both the present measurement result and the predictive measurement result satisfying the at least one condition.

16. The wireless device of claim 15, wherein the at least one processor is further adapted to:
evaluate the at least one condition based on both the present measurement result and the predictive measurement result.

17. The wireless device of claim 15,
wherein the at least one condition includes a first condition for the present measurement result and/or a second condition for the predictive measurement result.

18. The wireless device of claim 17,
wherein the conditional mobility to the target cell is performed based on both the first condition and the second condition being satisfied.

19. The wireless device of claim 17, wherein the at least one processor is further adapted to:
skip performing the conditional mobility to the target cell based on that the first condition is satisfied but the second condition is not satisfied.

20.-31. (canceled)

32. A base station, comprising:
a transceiver;
a memory; and
a processor operatively coupled to the transceiver and the memory, and adapted to:
control the transceiver to transmit, to a wireless device, a configuration of a conditional mobility for a target cell including at least one condition,
wherein the conditional mobility to the target cell is performed based on both a present measurement result for the target cell and a predictive measurement result for the target cell satisfying the at least one condition,
wherein the present measurement result for the target cell is acquired by the wireless device at a first time point, and
wherein the predictive measurement result for the target cell is derived by the wireless device for a second time point.
